(19) United States
(12) Patent Application Publication
(10) Pub. No.: US 2019/0303768 A1
(43) Pub. Date: Oct. 3, 2019

(54) Community Question Answering-Based Article Recommendation Method, System, and User Device

(71) Applicant: Huawei Technologies Co., Ltd., Shenzhen (CN)

(72) Inventors: Xi Zhang, Shenzhen (CN); Lin Ma, Shenzhen (CN); Xin Jiang, Hong Kong (CN); Hang Li, Shenzhen (CN)

(21) Appl. No.: 16/444,618

(22) Filed: Jun. 18, 2019

Related U.S. Application Data
(63) Continuation of application No. PCT/CN2017/117533, filed on Dec. 20, 2017.

(30) Foreign Application Priority Data
Dec. 30, 2016 (CN) 201611263447.3

(51) Int. Cl. G06N 5/02; G06N 20/00

(52) U.S. Cl. CPC G06N 5/02; G06N 20/00

(57) ABSTRACT

A community question answering-based article recommendation system, user device, and method includes obtaining text information of a question for a target article; constructing 2-tuple information using the text information of the question and modal content information of each of a plurality of preset articles in a preset article set; inputting each piece of 2-tuple information into a preset matching model; calculating, with reference to a preset matching model parameter, a score of matching between each preset article and the question; and outputting an article recommendation list for the question for the target article based on the scores of matching between the plurality of preset articles and the question for the target article.

### CROSS-REFERENCE TO RELATED APPLICATIONS

This application is a continuation application of International Application No. PCT/CN2017/117533, filed on Dec. 20, 2017, which claims priority to Chinese patent application number 201611263447.3 filed on Dec. 30, 2016, the disclosures of the aforementioned applications are hereby incorporated by reference in their entireties.

### TECHNICAL FIELD

This application relates to the field of big data technologies, and in particular, to a community question answering-based article recommendation method, system, and user device.

### BACKGROUND

An article recommendation system is a system tool that can actively excavate a preference of a user from massive articles including commodities, movies, books, music, and other information content, and recommend a preferred article to the user. When the user cannot accurately describe a requirement, the article recommendation system can help the user filter information and help the user quickly discover a required resource, thereby preventing people from drowning in enormous and disorderly network resources.

Focusing on improving accuracy of the article recommendation system, three main branches are derived: content-based recommendation, collaborative filtering-based recommendation, and hybrid model-based recommendation. A content-based recommendation algorithm is to match a content description of a user and an attribute description of an article in the system, and return an article with a relatively high matching degree to the user as a result. A collaborative filtering-based algorithm is to predict a potential interest and preference of a user based on historical behavior of the user. A hybrid recommendation algorithm is to combine the foregoing two ideas to achieve a better recommendation effect. Compared with conventional information retrieval, the recommendation system can “actively discover” an article that may be preferred by a user when the user has an ambiguous search intention, and return a result better satisfying the user.

However, a currently existing article recommendation system has a relatively simple interaction form, and the system unilaterally pushes an article list to a user without considering another possible interaction scenario. For example, when the user cannot give a specific name of an article but can provide some feature or knowledge descriptions of a related article, the conventional article recommendation system cannot recommend an article to the user based on the descriptions.

### SUMMARY

Embodiments of the present disclosure provide a community question answering-based article recommendation method, system, and user device, to provide an article recommendation list based on a natural statement question entered by a user, thereby improving article recommendation precision and optimizing user experience of an article recommendation system.

A first aspect of the embodiments of the present disclosure provides a community question answering-based article recommendation method, including obtaining text information of a question for a target article, and constructing 2-tuple information by using the text information of the question and modal content information of each of a plurality of preset articles in a preset article set, where the modal content information is used to represent a feature of the preset article, and the 2-tuple information includes the text information of the question and the modal content information of the preset article; inputting each piece of 2-tuple information into a preset matching model, and calculating, with reference to a preset matching model parameter, a score of matching between each preset article and the question, where the preset matching model is used to match each preset article in the preset article set and the question for the target article, and output a corresponding matching score; and outputting an article recommendation list for the question for the target article based on the scores of matching between the plurality of preset articles and the question for the target article.

In the article recommendation method, the 2-tuple information is constructed by using the text information of the question and the modal content information of the article, and the 2-tuple information is used as input of the preset matching model. Then the scores of matching between the question and the plurality of articles in the preset article set are calculated with reference to the preset matching model parameter, and the article recommendation list is output based on the matching scores. The preset matching model parameter may be obtained by training a large quantity of training samples, thereby helping improve article recommendation precision.

In an implementation, inputting each piece of 2-tuple information into a preset matching model, and calculating, with reference to a preset matching model parameter, a score of matching between each preset article and the question includes inputting, into the preset matching model, modal content information of a preset article and text information of the question for the target article that are corresponding to each piece of 2-tuple information; loading the preset matching model parameter as a matching score calculation weight of the preset matching model; and calculating, based on the matching score calculation weight, the score of matching between the preset article and the question for the target article, and using the matching score obtained through calculation as output of the preset matching model.

In an implementation, before obtaining the text information of a question for a target article, the method further includes extracting the modal content information of the preset article in the preset article set, and extracting, from a community question answering database based on a name of the preset article, text information of a question related to the preset article; constructing a 2-tuple information training sample for the preset article with reference to the modal content information of the preset article and the text information of the question related to the preset article; and inputting the 2-tuple information training sample into the preset matching model for training, to obtain the corresponding preset matching model parameter.

The text information of the question related to the preset article is extracted from the community question answering database, and the 2-tuple information training sample for the preset article is constructed. The community question answering database usually includes a large quantity of question-answer combinations. Therefore, richness of training samples can be ensured, thereby helping improve performance of the matching model and optimizing the matching model parameter, and further improving article recommendation precision.

In an implementation, the modal content information includes at least one of introduction text information, tag information, or image display information of the preset article, and before the obtaining text information of an online question for a target article, the method further includes constructing the preset matching model based on the modal content information; where the preset matching model is used to match the text information of the question and the modal content information that are in the input 2-tuple information, and output a corresponding matching score.

In an implementation, if the modal content information is the introduction text information of the preset article, constructing the preset matching model based on the modal content information includes constructing a feature vector v_{qe}∈R^{m} of text information of a question related to the preset article, where R is Euclidean space, and m is a dimension of the feature vector v_{qe} of the text information of the question; constructing a feature vector vₜₑₓₜ∈Rⁿ of the introduction text information of the preset article, where n is a dimension of the feature vector vₜₑₓₜ of the introduction text information; projecting the feature vector v_{qe} of the text information of the question and the feature vector vₜₑₓₜ of the introduction text information to space of a same dimension by using linear projection matrices L_{qe}∈R^{m×k} and Lₜₑₓₜ∈R^{n×k}; and constructing, by using an inner product of hidden layer features, a text matching model Sₜₑₓₜ(v_{qe},vₜₑₓₜ)=<L_{qe}v_{qe},Lₜₑₓₜvₜₑₓₜ>=v^{T}_{qe}L^{T}_{qe}Lₜₑₓₜvₜₑₓₜ for matching the text information of the question and the introduction text information, where {L_{qe},Lₜₑₓₜ}∈Θ is a parameter of the text matching model for matching the text information of the question and the introduction text information, and Θ is a parameter set of the text matching model.

In an implementation, if the modal content information is the introduction text information of the preset article, constructing the preset matching model based on the modal content information includes dividing text information of a question related to the preset article into a plurality of semantic units, and constructing a word feature vector vⁱ_{qe},i=1, . . . ,n of each semantic unit; dividing the introduction text information of the preset article into a plurality of semantic units, and constructing a word feature vector vⁱₜₑₓₜ,i=1, . . . ,m of each semantic unit; converting the text information of the question into a word feature vector representation z_{qe}=CNN_{qe}([v¹_{qe},v²_{qe}, . . . ,vⁿ_{qe}];θ_{qe}) by using a convolutional neural network CNN_{qe}(•), where θ_{qe} is a parameter of the convolutional neural network; converting the introduction text information into a word feature vector representation zₜₑₓₜ=CNNₜₑₓₜ([vₜₑₓₜ¹,vₜₑₓₜ², . . . ,vₜₑₓₜ^{m}];θₜₑₓₜ) by using a convolutional neural network CNNₜₑₓₜ(•), where θₜₑₓₜ is a parameter of the convolutional neural network; and constructing, by using a feed-forward neural network MLP(•), a text matching model Sₜₑₓₜ(z_{qe},zₜₑₓₜ)=MLP([z_{qe};zₜₑₓₜ];wₜₑₓₜ) for matching the text information of the question and the introduction text information, where wₜₑₓₜ is a parameter of the feed-forward neural network, where {θ_{qe},θₜₑₓₜ,wₜₑₓₜ}∈Θ is a parameter of the text matching model for matching the text information of the question and the introduction text information, and Θ is a parameter set of the text matching model.

In an implementation, if the modal content information is the tag information of the preset article, constructing the preset matching model based on the modal content information includes constructing a feature vector v_{qe}∈R^{m} of text information of a question related to the preset article, where R is Euclidean space, and m is a dimension of the feature vector v_{qe} of the text information of the question; constructing a feature vector v_{tag}∈Rⁿ of the tag information of the preset article, where n is a dimension of the feature vector v_{tag} of the tag information; projecting the feature vector v_{qe} of the text information of the question and the feature vector v_{tag} of the tag information to space of a same dimension by using linear projection matrices L_{qe}∈R^{m×k} and L_{tag}∈R^{n×k}; and constructing, by using an inner product of hidden layer features, a tag matching model S_{tag}(v_{qe},v_{tag})=<L_{qe}v_{qe},L_{tag}v_{tag}>=v^{T}_{qe}L^{T}_{qe}L_{tag}v_{tag} matching the text information of the question and the tag information, where {L_{qe},L_{tag}}∈Θ is a parameter of the tag matching model matching the text information of the question and the tag information, and Θ is a parameter set of the tag matching model.

In an implementation, if the modal content information is the tag information of the preset article, constructing the preset matching model based on the modal content information includes dividing text information of a question related to the preset article into a plurality of semantic units, and constructing a word feature vector vⁱ_{qe},i=1, . . . ,n of each semantic unit; dividing the tag information of the preset article into a plurality of semantic units, and constructing a word feature vector vⁱ_{tag},i=1, . . . ,m of each semantic unit; converting the text information of the question into a word feature vector representation z_{qe}=CNN_{qe}([v_{qe}¹, v_{qe}², . . . ,v_{qe}ⁿ];θ_{qe}) by using a convolutional neural network CNN_{qe}(•), where θ_{qe} is a parameter of the convolutional neural network; converting the tag information into a word feature vector representation z_{tag}=CNN_{tag}([v¹_{tag},v²_{tag}, . . . ,v^{m}_{tag}];θ_{tag}) by using a convolutional neural network CNN_{tag}(•), where θ_{tag} is a parameter of the convolutional neural network; and constructing, by using a feed-forward neural network MLP(•), a tag matching model S_{tag}(z_{qe},z_{tag})=MLP([z_{qe};z_{tag}];w_{tag}) matching the text information of the question and the tag information, where w_{tag} is a parameter of the feed-forward neural network, where {θ_{qe},θ_{tag},w_{tag}}∈Θ is a parameter of the tag matching model matching the text information of the question and the tag information, and Θ is a parameter set of the tag matching model.

In an implementation, if the modal content information is the image display information of the preset article, constructing the preset matching model based on the modal content information includes constructing a feature vector vᵢₘ of the image display information of the preset article; dividing text information of a question related to the preset article into a plurality of semantic units, and constructing a word feature vector vⁱ_{wd} of each semantic unit; calculating, based on the feature vector vᵢₘ of the image display information and the word feature vectors vⁱ_{wd} of the plurality of semantic units, a feature vector v_{JR} of information about matching between the question and an image; and constructing, based on the feature vector v_{JR} of the information about matching between the question and the image, an image matching model S_{img}=wₛ(σ(wₘ(v_{JR})+bₘ))+bₛ matching the text information of the question and the image display information, where {wₘ, bₘ}∈Θ is a hidden layer parameter, {wₛ,bₛ}∈Θ is an output layer parameter and is used to calculate a final matching score S_{img}, and Θ is a parameter set of the image matching model.

In an implementation, if the modal content information includes the introduction text information, the tag information, and the image display information of the preset article, constructing the preset matching model based on the modal content information includes constructing a text matching model Sₜₑₓₜ^{(p,q)} matching the introduction text information and text information of a question related to the preset article; constructing a tag matching model S_{tag}^{(p,q)} matching the tag information and the text information of the question related to the preset article; constructing an image matching model S_{img}^{(p,q)} matching the image display information and the text information of the question related to the preset article; and constructing, based on the text matching model Sₜₑₓₜ^{(p,q)}, the tag matching model S_{tag}^{(p,q)}, and the image matching model S_{img}^{(p,q)}, a multi-modal merging matching model for the question related to the preset article

$${arg max}_{Θ} S ( Θ ) = {argmax}_{Θ} {\sum }_{< p , q > ∈ D} g ( {S}_{img}^{( p , q )} , {S}_{text}^{( p , q )} , {S}_{tag}^{( p , q )} ; Θ ) + λΩ ( Θ ) ,$$

where Θ is a parameter set of the multi-modal merging matching model, D is a 2-tuple information training sample set of the preset article, Ω(•) is a regularization item and is used to avoid model over-fitting that may be caused by excessive parameters, and λ is a hyperparameter and is used to balance functions of correlation matching and the regularization item in an optimization problem.

The multi-modal merging matching model matching the question and the article is established, so that the article recommendation method can be applied to an application scenario in which users are diversified and a requirement and an intention of a user are ambiguous. Merging of a plurality of pieces of modal content information helps improve article recommendation precision in the application scenario in which users are diversified and a requirement and an intention of a user are ambiguous.

A second aspect of the embodiments of the present disclosure provides a community question answering-based article recommendation system, including a 2-tuple construction unit configured to obtain text information of a question for a target article, and construct 2-tuple information by using the text information of the question and modal content information of each of a plurality of preset articles in a preset article set, where the modal content information is used to represent a feature of the preset article, and the 2-tuple information includes the text information of the question and the modal content information of the preset article; a matching score calculation unit configured to input each piece of 2-tuple information into a preset matching model, and calculate, with reference to a preset matching model parameter, a score of matching between each preset article and the question, where the preset matching model is used to match each preset article in the preset article set and the question for the target article, and output a corresponding matching score; and an article recommendation unit, configured to output an article recommendation list for the question for the target article based on the scores of matching between the plurality of preset articles and the question for the target article.

In the article recommendation system, the 2-tuple information is constructed by using the text information of the question and the modal content information of the article, and the 2-tuple information is used as input of the preset matching model. Then the scores of matching between the question and the plurality of articles in the preset article set are calculated with reference to the preset matching model parameter, and the article recommendation list is output based on the matching scores. The preset matching model parameter may be obtained by training a large quantity of training samples, thereby helping improve article recommendation precision.

In an implementation, the matching score calculation unit is further configured to input, into the preset matching model, modal content information of a preset article and text information of the question for the target article that are corresponding to each piece of 2-tuple information; load the preset matching model parameter as a matching score calculation weight of the preset matching model; and calculate, based on the matching score calculation weight, the score of matching between the preset article and the question for the target article, and use the matching score obtained through calculation as output of the preset matching model.

In an implementation, the system further includes a modality extraction unit configured to extract the modal content information of the preset article in the preset article set, and extract, from a community question answering database based on a name of the preset article, text information of a question related to the preset article; a training sample construction unit, configured to construct a 2-tuple information training sample for the preset article with reference to the modal content information of the preset article and the text information of the question related to the preset article; and a model parameter training unit, configured to input the 2-tuple information training sample into the preset matching model for training, to obtain the corresponding preset matching model parameter.

The text information of the question related to the preset article is extracted from the community question answering database, and the 2-tuple information training sample for the preset article is constructed. The community question answering database usually includes a large quantity of question-answer combinations. Therefore, richness of training samples can be ensured, thereby helping improve performance of the matching model and optimizing the matching model parameter, and further improving article recommendation precision.

In an implementation, the system further includes a matching model construction unit, configured to construct the preset matching model based on the modal content information; where the preset matching model is used to match the text information of the question and the modal content information that are in the input 2-tuple information, and output a corresponding matching score.

In an implementation, the matching model construction unit includes a question feature construction subunit, configured to construct a feature vector v_{qe}∈R^{m} of text information of a question related to the preset article, where R is Euclidean space, and m is a dimension of the feature vector v_{qe} of the text information of the question; a modal feature construction subunit, configured to construct a feature vector vₜₑₓₜ∈Rⁿ of introduction text information of the preset article, where n is a dimension of the feature vector vₜₑₓₜ of the introduction text information; a spatial projection subunit, configured to project the feature vector v_{qe} of the text information of the question and the feature vector vₜₑₓₜ of the introduction text information to space of a same dimension by using linear projection matrices L_{qe}∈R^{m×k} and Lₜₑₓₜ∈R^{n×k}; and a text model construction subunit, configured to construct, by using an inner product of hidden layer features, a text matching model Sₜₑₓₜ(v_{qe},vₜₑₓₜ)=<L_{qe}v_{qe},Lₜₑₓₜvₜₑₓₜ>=v^{T}_{qe}L^{T}_{qe}Lₜₑₓₜvₜₑₓₜ for matching the text information of the question and the introduction text information, where {L_{qe},Lₜₑₓₜ}∈Θ is a parameter of the text matching model for matching the text information of the question and the introduction text information, and Θ is a parameter set of the text matching model.

In an implementation, the matching model construction unit includes a question feature construction subunit configured to divide text information of a question related to the preset article into a plurality of semantic units, and construct a word feature vector vⁱ_{qe},i=1, . . . ,n of each semantic unit; a modal feature construction subunit configured to divide introduction text information of the preset article into a plurality of semantic units, and construct a word feature vector vⁱₜₑₓₜ,i=1, . . . ,m of each semantic unit; a question text conversion subunit, configured to convert the text information of the question into a word feature vector representation z_{qe}=CNN_{qe}([v¹_{qe},v²_{qe}, . . . ,vⁿ_{qe}];θ_{qe}) by using a convolutional neural network CNN_{qe}(•), where θ_{qe} is a parameter of the convolutional neural network; an introduction text conversion subunit, configured to convert the introduction text information into a word feature vector representation zₜₑₓₜ=CNNₜₑₓₜ([vₜₑₓₜ¹,vₜₑₓₜ², . . . ,vₜₑₓₜ^{m}];θₜₑₓₜ) by using a convolutional neural network CNNₜₑₓₜ(•), where θₜₑₓₜ is a parameter of the convolutional neural network; and a text model construction subunit, configured to construct, by using a feed-forward neural network MLP(•), a text matching model Sₜₑₓₜ(z_{qe},zₜₑₓₜ)=MLP([z_{qe}; zₜₑₓₜ]; wₜₑₓₜ) for matching the text information of the question and the introduction text information, where wₜₑₓₜ is a parameter of the feed-forward neural network, where {θ_{qe},θₜₑₓₜ,wₜₑₓₜ}∈Θ is a parameter of the text matching model for matching the text information of the question and the introduction text information, and Θ is a parameter set of the text matching model.

In an implementation, the matching model construction unit includes a question feature construction subunit configured to construct a feature vector v_{qe}∈R^{m} of text information of a question related to the preset article, where R is Euclidean space, and m is a dimension of the feature vector v_{qe} of the text information of the question; a modal feature construction subunit, configured to construct a feature vector v_{tag}∈Rⁿ of tag information of the preset article, where n is a dimension of the feature vector v_{tag} of the tag information; a spatial projection subunit, configured to project the feature vector v_{qe} of the text information of the question and the feature vector v_{tag} of the tag information to space of a same dimension by using linear projection matrices L_{qe}∈R^{m×k} and L_{tag}∈R^{n×k}; and a tag model construction subunit, configured to construct, by using an inner product of hidden layer features, a tag matching model S_{tag}(v_{qe},v_{tag})=<L_{qe}v_{qe},L_{ag}v_{tag}>=v^{T}_{qe}L^{T}_{qe}L_{tag}v_{tag} matching the text information of the question and the tag information, where {L_{qe},L_{tag}}∈Θ is a parameter of the tag matching model matching the text information of the question and the tag information, and Θ is a parameter set of the tag matching model.

In an implementation, the matching model construction unit includes a question feature construction subunit configured to divide text information of a question related to the preset article into a plurality of semantic units, and construct a word feature vector v_{qe}ⁱ,i=1, . . . ,n of each semantic unit; a modal feature construction subunit configured to divide tag information of the preset article into a plurality of semantic units, and construct a word feature vector v_{tag}ⁱ,i=1, . . . ,m of each semantic unit; a question text conversion subunit, configured to convert the text information of the question into a word feature vector representation z_{qe}=CNN_{qe}([v¹_{qe},v²_{qe}, . . . ,vⁿ_{qe}];θ_{qe}) by using a convolutional neural network CNN_{qe}(•), where θ_{qe} is a parameter of the convolutional neural network; a tag text conversion subunit, configured to convert the tag information into a word feature vector representation z_{tag}=CNN_{tag}([v_{tag}¹,v_{tag}², . . . ,v_{tag}^{m}];θ_{tag}) by using a convolutional neural network CNN_{tag}(•), where θ_{tag} is a parameter of the convolutional neural network; and a tag model construction subunit, configured to construct, by using a feed-forward neural network MLP(•), a tag matching model S_{tag}(z_{qe},z_{tag})=MLP([z_{qe};z_{tag}];w_{tag}) matching the text information of the question and the tag information, where w_{tag} is a parameter of the feed-forward neural network, where {θ_{qe}, θ_{tag}, w_{tag}}∈Θ is a parameter of the tag matching model matching the text information of the question and the tag information, and Θ is a parameter set of the tag matching model.

In an implementation, the matching model construction unit includes a question feature construction subunit configured to divide text information of a question related to the preset article into a plurality of semantic units, and construct a word feature vector vⁱ_{wd} of each semantic unit; a modal feature construction subunit, configured to construct a feature vector vᵢₘ of image display information of the preset article; a matching feature construction subunit, configured to calculate, based on the feature vector vᵢₘ of the image display information and the word feature vectors vⁱ_{wd} of the plurality of semantic units, a feature vector v_{JR} of information about matching between the question and an image; and an image model construction subunit, configured to construct, based on the feature vector v_{JR} of the information about matching between the question and the image, an image matching model S_{img}=wₛ(σ(wₘ(v_{JR})+bₘ))+bₛ matching the text information of the question and the image display information, where {wₘ,bₘ}∈Θ is a hidden layer parameter, {wₛ,bₛ}∈Θ is an output layer parameter and is used to calculate a final matching score S_{img}, and Θ is a parameter set of the image matching model.

In an implementation, the matching model construction unit includes a text model construction subunit configured to construct a text matching model Sₜₑₓₜ^{(p,q)} matching the introduction text information and text information of a question related to the preset article; a tag model construction subunit, configured to construct a tag matching model S_{tag}^{(p,q)} matching the tag information and the text information of the question related to the preset article; an image model construction subunit, configured to construct an image matching model S_{img}^{(p,q)} matching the image display information and the text information of the question related to the preset article; and a merging model construction subunit, configured to construct, based on the text matching model Sₜₑₓₜ^{(p,q)}, the tag matching model S_{tag}^{(p,q)}, and the image matching model S_{img}^{(p,q)}, a multi-modal merging matching model for the question related to the preset article:

$${arg max}_{Θ} S ( Θ ) = {argmax}_{Θ} {\sum }_{< p , q > ∈ D} g ( {S}_{img}^{( p , q )} , {S}_{text}^{( p , q )} , {S}_{tag}^{( p , q )} ; Θ ) + λΩ ( Θ ) ,$$

where Θ is a parameter set of the multi-modal merging matching model, D is a 2-tuple information training sample set of the preset article, Ω(•) is a regularization item and is used to avoid model over-fitting that may be caused by excessive parameters, and λ is a hyperparameter and is used to balance functions of correlation matching and the regularization item in an optimization problem.

The multi-modal merging matching model matching the question and the article is established, so that the article recommendation method can be applied to an application scenario in which users are diversified and a requirement and an intention of a user are ambiguous. Merging of a plurality of pieces of modal content information helps improve article recommendation precision in the application scenario in which users are diversified and a requirement and an intention of a user are ambiguous.

A third aspect of the embodiments of the present disclosure provides a user device, including at least one processor, a memory, a communications interface, and a bus, where the at least one processor, the memory, and the communications interface are connected and communicate with each other by using the bus, the memory is configured to store executable program code, and the processor is configured to invoke the executable program code stored in the memory and perform the following operations including obtaining text information of a question for a target article, and constructing 2-tuple information by using the text information of the question and modal content information of each of a plurality of preset articles in a preset article set, where the modal content information is used to represent a feature of the preset article, and the 2-tuple information includes the text information of the question and the modal content information of the preset article; inputting each piece of 2-tuple information into a preset matching model, and calculating, with reference to a preset matching model parameter, a score of matching between each preset article and the question, where the preset matching model is used to match each preset article in the preset article set and the question for the target article, and output a corresponding matching score; and outputting an article recommendation list for the question for the target article based on the scores of matching between the plurality of preset articles and the question for the target article.

The 2-tuple information is constructed by using the text information of the question and the modal content information of the article, and the 2-tuple information is used as input of the preset matching model. Then the scores of matching between the question and the plurality of articles in the preset article set are calculated with reference to the preset matching model parameter, and the article recommendation list is output based on the matching scores. The preset matching model parameter may be obtained by training a large quantity of training samples, thereby helping improve article recommendation precision.

In an implementation, the inputting each piece of 2-tuple information into a preset matching model, and calculating, with reference to a preset matching model parameter, a score of matching between each preset article and the question includes inputting, into the preset matching model, modal content information of a preset article and text information of the question for the target article that are corresponding to each piece of 2-tuple information; loading the preset matching model parameter as a matching score calculation weight of the preset matching model; and calculating, based on the matching score calculation weight, the score of matching between the preset article and the question for the target article, and using the matching score obtained through calculation as output of the preset matching model.

In an implementation, before the obtaining text information of a question for a target article, the operation further includes extracting the modal content information of the preset article in the preset article set, and extracting, from a community question answering database based on a name of the preset article, text information of a question related to the preset article; constructing a 2-tuple information training sample for the preset article with reference to the modal content information of the preset article and the text information of the question related to the preset article; and inputting the 2-tuple information training sample into the preset matching model for training, to obtain the corresponding preset matching model parameter.

The text information of the question related to the preset article is extracted from the community question answering database, and the 2-tuple information training sample for the preset article is constructed. The community question answering database usually includes a large quantity of question-answer combinations. Therefore, richness of training samples can be ensured, thereby helping improve performance of the matching model and optimizing the matching model parameter, and further improving article recommendation precision.

In an implementation, the modal content information includes at least one of introduction text information, tag information, or image display information of the preset article, and before the obtaining text information of an online question for a target article, the operation further includes constructing the preset matching model based on the modal content information; where the preset matching model is used to match the text information of the question and the modal content information that are in the input 2-tuple information, and output a corresponding matching score.

In an implementation, if the modal content information is the introduction text information of the preset article, the constructing the preset matching model based on the modal content information includes constructing a feature vector v_{qe}∈R^{m} of text information of a question related to the preset article, where R is Euclidean space, and m is a dimension of the feature vector v_{qe} of the text information of the question; constructing a feature vector vₜₑₓₜ∈Rⁿ of the introduction text information of the preset article, where n is a dimension of the feature vector vₜₑₓₜ of the introduction text information; projecting the feature vector v_{qe} of the text information of the question and the feature vector vₜₑₓₜ of the introduction text information to space of a same dimension by using linear projection matrices L_{qe}∈R^{m×k} and Lₜₑₓₜ∈R^{n×k}; and constructing, by using an inner product of hidden layer features, a text matching model Sₜₑₓₜ(v_{qe},vₜₑₓₜ)=<L_{qe}v_{qe},Lₜₑₓₜvₜₑₓₜ>=v^{T}_{qe}L^{T}_{qe}Lₜₑₓₜvₜₑₓₜ for matching the text information of the question and the introduction text information, where {L_{qe}, Lₜₑₓₜ}∈Θ is a parameter of the text matching model for matching the text information of the question and the introduction text information, and Θ is a parameter set of the text matching model.

In an implementation, if the modal content information is the introduction text information of the preset article, constructing the preset matching model based on the modal content information includes dividing text information of a question related to the preset article into a plurality of semantic units, and constructing a word feature vector vⁱ_{qe},i=1, . . . ,n of each semantic unit; dividing the introduction text information of the preset article into a plurality of semantic units, and constructing a word feature vector vₜₑₓₜⁱ,i=1, . . . ,m of each semantic unit; converting the text information of the question into a word feature vector representation z_{qe}=CNN_{qe}([v_{qe}¹,v_{qe}², . . . ,v_{qe}ⁿ];θ_{qe}) by using a convolutional neural network CNN_{qe}(•), where θ_{qe} is a parameter of the convolutional neural network; converting the introduction text information into a word feature vector representation zₜₑₓₜ=CNNₜₑₓₜ([vₜₑₓₜ¹,vₜₑₓₜ², . . . ,vₜₑₓₜ^{m}];θₜₑₓₜ) by using a convolutional neural network CNNₜₑₓₜ(•), where θₜₑₓₜ is a parameter of the convolutional neural network; and constructing, by using a feed-forward neural network MLP(•), a text matching Sₜₑₓₜ(z_{qe},zₜₑₓₜ)=MLP([z_{qe};zₜₑₓₜ]; wₜₑₓₜ) for matching the text information of the question and the introduction text information, where wₜₑₓₜ is a parameter of the feed-forward neural network, where {θ_{qe},θₜₑₓₜ,wₜₑₓₜ}∈Θ is a parameter of the text matching model for matching the text information of the question and the introduction text information, and Θ is a parameter set of the text matching model.

In an implementation, if the modal content information is the tag information of the preset article, constructing the preset matching model based on the modal content information includes constructing a feature vector v_{qe}∈R^{m} of text information of a question related to the preset article, where R is Euclidean space, and m is a dimension of the feature vector v_{qe} of the text information of the question; constructing a feature vector v_{tag}∈Rⁿ of the tag information of the preset article, where n is a dimension of the feature vector v_{tag} of the tag information; projecting the feature vector v_{qe} of the text information of the question and the feature vector v_{tag} of the tag information to space of a same dimension by using linear projection matrices L_{qe}∈R^{m×k} and L_{tag}∈R^{n×k}; and constructing, by using an inner product of hidden layer features, a tag matching model S_{tag}(v_{qe},v_{tag})=<L_{qe}v_{qe},L_{tag}v_{tag}>=v^{T}_{qe}L^{T}_{qe}L_{tag}v_{tag} matching the text information of the question and the tag information, where {L_{qe}, L_{tag}}∈Θ is a parameter of the tag matching model matching the text information of the question and the tag information, and Θ is a parameter set of the tag matching model.

In an implementation, if the modal content information is the tag information of the preset article, constructing the preset matching model based on the modal content information includes dividing text information of a question related to the preset article into a plurality of semantic units, and constructing a word feature vector vⁱ_{qe},i=1, . . ., n of each semantic unit; dividing the tag information of the preset article into a plurality of semantic units, and constructing a word feature vector vⁱ_{tag},i=1, . . . ,m of each semantic unit; converting the text information of the question into a word feature vector representation z_{qe}=CNN_{qe}([v_{qe}¹,v_{qe}², . . . ,v_{qe}ⁿ];θ_{qe}) by using a convolutional neural network CNN_{qe}(•), where θ_{qe} is a parameter of the convolutional neural network; converting the tag information into a word feature vector representation z_{tag}=CNN_{tag}([v_{tag}¹,v_{tag}², . . . ,v_{tag}^{m}];θ_{tag}) by using a convolutional neural network CNN_{tag}(•), where θ_{tag} is a parameter of the convolutional neural network; and constructing, by using a feed-forward neural network MLP(•), a tag matching model S_{tag}(z_{qe},z_{tag})=MLP([z_{qe};z_{tag}];w_{tag}) matching the text information of the question and the tag information, where w_{tag} is a parameter of the feed-forward neural network, where {θ_{qe},θ_{tag},w_{tag}}∈Θ is a parameter of the tag matching model matching the text information of the question and the tag information, and Θ is a parameter set of the tag matching model.

In an implementation, if the modal content information is the image display information of the preset article, constructing the preset matching model based on the modal content information includes constructing a feature vector vᵢₘ of the image display information of the preset article; dividing text information of a question related to the preset article into a plurality of semantic units, and constructing a word feature vector vⁱ_{wd} of each semantic unit; calculating, based on the feature vector vᵢₘ of the image display information and the word feature vectors vⁱ_{wd} of the plurality of semantic units, a feature vector v_{JR} of information about matching between the question and an image; and constructing, based on the feature vector v_{JR} of the information about matching between the question and the image, an image matching model S_{img}=wₛ(σ(wₘ(v_{JR})+bₘ))+bₛ matching the text information of the question and the image display information, where {wₘ,bₘ}∈Θ is a hidden layer parameter, {wₛ,bₛ}∈Θ is an output layer parameter and is used to calculate a final matching score S_{img}, and Θ is a parameter set of the image matching model.

In an implementation, if the modal content information includes the introduction text information, the tag information, and the image display information of the preset article, the constructing the preset matching model based on the modal content information includes constructing a text matching model Sₜₑₓₜ^{(p,q)} matching the introduction text information and text information of a question related to the preset article; constructing a tag matching model S_{tag}^{(p,q)} matching the tag information and the text information of the question related to the preset article; constructing an image matching model S_{img}^{(p,q)} matching the image display information and the text information of the question related to the preset article; and constructing, based on the text matching model Sₜₑₓₜ^{(p,q)}, the tag matching model S_{tag}^{(p,q)}, and the image matching model S_{img}^{(p,q)}, a multi-modal merging matching model for the question related to the preset article:

$${arg max}_{Θ} S ( Θ ) = {arg max}_{Θ} {\sum }_{〈 p , q 〉 ∈ D} g ( {S}_{img}^{( p , q )} , {S}_{text}^{( p , q )} , {S}_{tag}^{( p , q )} ; Θ ) + λ Ω ( Θ ) ,$$

where Θ is a parameter set of the multi-modal merging matching model, D is a 2-tuple information training sample set of the preset article, Ω(•) is a regularization item and is used to avoid model over-fitting that may be caused by excessive parameters, and λ is a hyperparameter and is used to balance functions of correlation matching and the regularization item in an optimization problem.

The multi-modal merging matching model matching the question and the article is established, so that the article recommendation method can be applied to an application scenario in which users are diversified and a requirement and an intention of a user are ambiguous. In addition, article related knowledge is obtained from a community question answering, and a recommendation result having a high correlation with a question in natural language is automatically generated. Therefore, complex steps used during article selection can be reduced, thereby improving article recommendation accuracy while improving user experience.

### BRIEF DESCRIPTION OF DRAWINGS

FIG. 1 is a schematic flowchart of a community question answering-based article recommendation method according to an embodiment of the present disclosure;

FIG. 2 is a schematic diagram of a first sub-procedure of a community question answering-based article recommendation method according to an embodiment of the present disclosure;

FIG. 3A and FIG. 3B are schematic diagrams of image display information in a community question answering-based article recommendation method according to an embodiment of the present disclosure;

FIG. 4A and FIG. 4B are schematic diagrams of image display information in a community question answering-based article recommendation method according to an embodiment of the present disclosure;

FIG. 5 is a schematic structural diagram of a multi-modal merging matching model in a community question answering-based article recommendation method according to an embodiment of the present disclosure;

FIG. 6 is a schematic diagram of a second sub-procedure of a community question answering-based article recommendation method according to an embodiment of the present disclosure;

FIG. 7 is a schematic structural diagram of a text matching model in a community question answering-based article recommendation method according to an embodiment of the present disclosure;

FIG. 8 is a schematic diagram of a third sub-procedure of a community question answering-based article recommendation method according to an embodiment of the present disclosure;

FIG. 9 is a schematic diagram of a fourth sub-procedure of a community question answering-based article recommendation method according to an embodiment of the present disclosure;

FIG. 10 is a schematic structural diagram of an image matching model in a community question answering-based article recommendation method according to an embodiment of the present disclosure;

FIG. 11 is a schematic diagram of a fifth sub-procedure of a community question answering-based article recommendation method according to an embodiment of the present disclosure;

FIG. 12 is a schematic structural diagram of a community question answering-based article recommendation system according to an embodiment of the present disclosure;

FIG. 13 is a first schematic structural diagram of a matching model construction unit in a community question answering-based article recommendation system according to an embodiment of the present disclosure;

FIG. 14 is a second schematic structural diagram of a matching model construction unit in a community question answering-based article recommendation system according to an embodiment of the present disclosure;

FIG. 15 is a third schematic structural diagram of a matching model construction unit in a community question answering-based article recommendation system according to an embodiment of the present disclosure;

FIG. 16 is a fourth schematic structural diagram of a matching model construction unit in a community question answering-based article recommendation system according to an embodiment of the present disclosure;

FIG. 17 is a fifth schematic structural diagram of a matching model construction unit in a community question answering-based article recommendation system according to an embodiment of the present disclosure;

FIG. 18 is a sixth schematic structural diagram of a matching model construction unit in a community question answering-based article recommendation system according to an embodiment of the present disclosure; and

FIG. 19 is a schematic structural diagram of user device according to an embodiment of the present disclosure.

### DESCRIPTION OF EMBODIMENTS

The following describes the embodiments of the present disclosure with reference to accompanying drawings.

A community question answering is an interactive and open knowledge sharing platform developed under the background of Web2.0. A user can pose a question on any topic by using a question and answer community, and another user provides a possible answer. Because questions are answered by people, the community question answering usually can provide empirical help in a corresponding offline life of a user who poses a question. There are various machine learning tasks related to the community question answering, including expert discovery, user interest analysis, and answer satisfaction prediction.

Because questions and answers are main ways for a user to gain knowledge from the community question answering platform, one of basic tasks is to automatically generate a correct answer to a question posed by the user. A main challenge of this task lies in the following. Network data generated by the user is diversified and ambiguous, and this inevitably causes a “literal divide” between a question and an answer. The “literal divide” is shown in that a word used in a question and a related word in a corresponding answer are usually inconsistent. For example, the word “company” can be described as “company” or “firm” in English. If the “company” is used in a question and the “firm” is used in a related answer, the question may not accurately match the related answer due to a literal mismatch.

In terms of technical solution, a search model-based method is usually used to establish an index for a question and answer corpus. The task is considered as an information retrieval problem, and is to retrieve and return a text related to a question posed by a user. However, a current community question answering system emphasizes only answer generation while ignoring a final purpose of a question posed by a user, that is, obtaining of an entity of a questioned article. Therefore, the user still needs a complex online operation process after getting an answer.

An embodiment of the present disclosure provides a community question answering-based article recommendation method and system. From perspectives of accuracy and high efficiency of recommendation, community question answering data and a technical feature are used to merge a large amount of question and answer information in natural language, to support article recommendation when users are diversified and intention interaction is ambiguous.

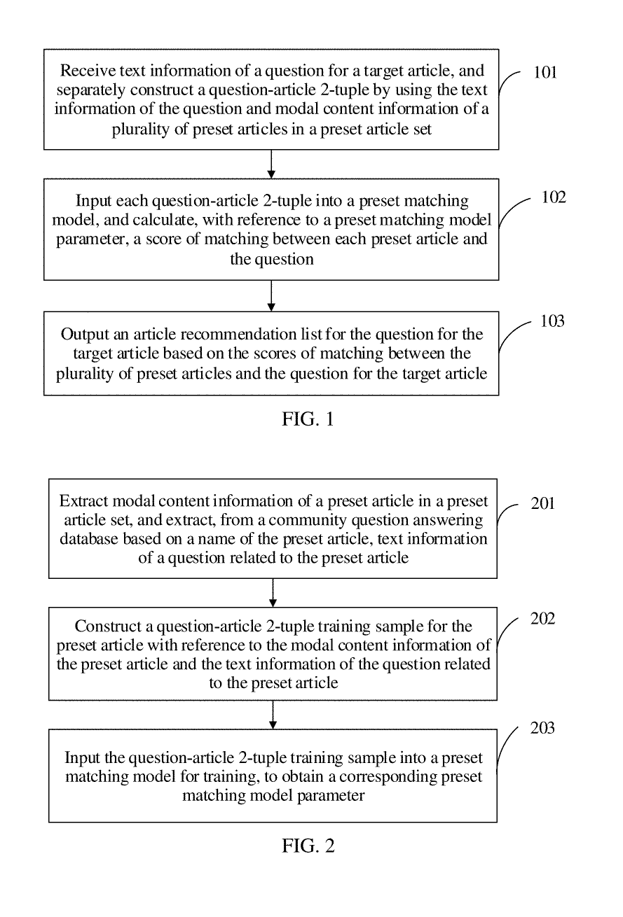

Referring to FIG. 1, the community question answering-based article recommendation method includes at least the following steps.

Step 101: Obtain text information of a question for a target article, and constructing 2-tuple information by using the text information of the question and modal content information of each of a plurality of preset articles in a preset article set, where the modal content information is used to represent a feature of the preset article, and the 2-tuple information includes the text information of the question and the modal content information of the preset article.

Step 102: Input each piece of 2-tuple information into a preset matching model, and calculate, with reference to a preset matching model parameter, a score of matching between each preset article and the question, where the preset matching model is used to match each preset article in the preset article set and the question for the target article, and output a corresponding matching score.

Step 103: Output an article recommendation list for the question for the target article based on the scores of matching between the plurality of preset articles and the question for the target article.

The text information may be a natural statement question, for example, “a game in which a little girl wearing in white journeys through mazes”. Correspondingly, the target article is a result that a user expects to obtain by searching the question, for example, “Monument Valley”. It may be understood that the preset article set may be a set of all articles that are extracted from a specific database in advance, for example, a set of all applications extracted from a Google Play application market or another application market such as Huawei.

The target article may be any preset article in the preset article set. The modal content information of the preset article may include one or more pieces of modal feature information that may be included in an attribute of the preset article, for example, introduction text information, tag information, and image display information. The 2-tuple information is separately constructed by using the text information of the question for the target article and the modal content information of each of the plurality of preset articles in the preset article set, and each piece of 2-tuple information is used as input of the trained preset matching model. Therefore, the scores of matching between the plurality of preset articles in the preset article set and the question for the target article may be calculated based on the matching model parameter obtained through training, and then the article recommendation list is provided for a user based on the matching scores. For example, for the question “a game in which a little girl wearing in white journeys through mazes”, through predictive matching performed by using the preset matching model, an output article recommendation list may be Monument Valley, Ghosts of Memories, Doors&Rooms, Machinarium, and the like in a sequence of matching scores.

Referring to FIG. 2, before the obtaining text information of a question for a target article, the method further includes the following steps.

Step 201: Extract the modal content information of the preset article in the preset article set, and extract, from a community question answering database based on a name of the preset article, text information of a question related to the preset article.

Step 202: Construct a 2-tuple information training sample for the preset article with reference to the modal content information of the preset article and the text information of the question related to the preset article.

Step 203: Input the 2-tuple information training sample into the preset matching model for training, to obtain the corresponding preset matching model parameter.

The preset matching model parameter is used to calculate the score of matching between each preset article and the online question for the target article.

In an embodiment, article information may be obtained from different data sources based on different modal content attributes such as introduction text information, tag information, and image display information of the preset article. In this embodiment, a method for extracting the modal content information of the preset article is as follows.

Introduction text information: The introduction text information of the preset article is constructed by using an application profile in an application market and an application description captured from BAIDU Baike.

Tag information: Tag data including noise may be obtained through manual annotation, third-party website capturing, segmented word extraction, or the like, and then a noise tag is filtered by using a machine learning algorithm, to construct the tag information of the preset article.

Image display information: The image display information of the preset article is constructed by using an application screenshot in an application market and a picture search result captured from GOOGLE.

In this embodiment, extraction, from the community question answering database, of a question related to the preset article and a correct answer, and construction of a question-article correlation pair set of the preset article may be divided into the following three steps.

(1) A community question answering platform (such as BAIDU Knows, ZHIHU, and QUORA) has a large amount of data about questions and corresponding answers of the questions. A web page is captured from the community question answering platform, and a question and an answer, of the question, that meets a condition are obtained through parsing. The answer is considered as a correct answer of the question, and a community question answering set is constructed by using questions and correct answers of the questions.

(2) Article related data is extracted from the community question answering set. Embodiment operations are as follows. A heuristic method is used to find, one by one, whether answer strings include article name information. If the answer string includes the article name information, the answer and a corresponding question of the answer are extracted; or if the answer string does not include the article name information, an extraction operation is not performed.

(3) Construction of the question-article correlation pair set: A correlation between two extracted entities, namely, a question and an article, is represented by 2-tuple information. If the question and the article are in a same piece of 2-tuple information, it is considered that the question is related to the article, and the 2-tuple information is used as matching model supervision information, that is, a training sample.

In this embodiment, the 2-tuple information training sample of the preset article may be constructed by using the following method.

Training data is formed by using a question-article 2-tuple, and a training set is constructed by using all the 2-tuples. A question is described by using a text, and an article is described by using modal content information. In an embodiment, 2-tuple information is established by using text information of the question and the modal content information of the corresponding article. For a mobile phone application in an application market, multi-modal content information may include introduction text information, tag information, and image display information (a screenshot or poster of the application) of the application. For example:

Training Sample 1:

Question: a three-dimensional rotary castle bridge building game.

Answer: it may be Monument Valley.

2-tuple: <three-dimensional rotary castle bridge building game, Monument Valley>

Introduction text information: it is a puzzle game in which players operate the princess Ida in a maze that seems impossible to exist.

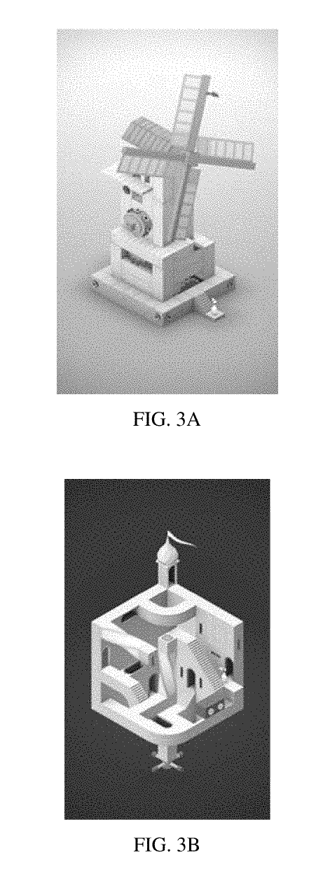

Tag information: puzzle, brain-beneficial, adventure, maze, gameImage display information: shown in FIG. 3A and FIG. 3B.

Training Sample 2:

Question: what is the name of the Android game endorsed by star A.

Answer: a mobile game named Boom Beach.

2-tuple: <what is the name of the Android game endorsed by star A, Boom Beach>.

Introduction text information: it is a combat strategy game developed by SUPERCELL OY in Finland and issued by SUPERCELL OY and KUNLUN Game and global players are in a same server.

Tag information: war, tower defense, and business simulation.

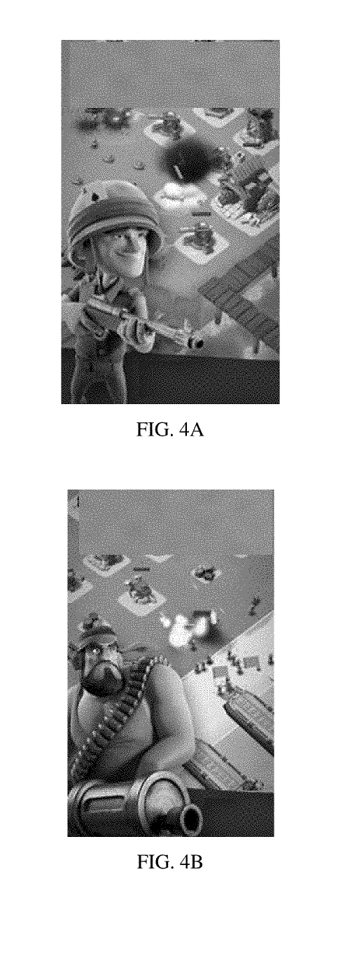

Image display information: shown in FIG. 4A and FIG. 4B.

It may be understood that an article name in the 2-tuple may be replaced with any one or more pieces of modal content information of a corresponding article, to form a 2-tuple training sample by using the question and a modality of the corresponding article. The 2-tuple information training sample is constructed by collecting a large amount of multi-modal content information of the preset article. Then the preset matching model is trained by using the training sample, and a likelihood function of training data is maximized by using an optimization algorithm, to determine a matching model parameter set.

After a matching model parameter is determined, an article may be recommended by using the preset matching model. In an embodiment, inputting each piece of 2-tuple information into a preset matching model, and calculating, with reference to a preset matching model parameter, a score of matching between each preset article and the question includes inputting, into the preset matching model, modal content information of a preset article and text information of the question for the target article that are corresponding to each piece of 2-tuple information; loading the preset matching model parameter as a matching score calculation weight of the preset matching model; and calculating, based on the matching score calculation weight, the score of matching between the preset article and the question for the target article, and using the matching score obtained through calculation as output of the preset matching model.

After the preset matching model is trained by using the 2-tuple information training sample, the preset matching model parameter corresponding to the training sample may be obtained. The preset matching model parameter is loaded as the matching score calculation weight of the preset matching model, so that when the 2-tuple information is input into the preset matching model, the preset matching model may calculate, based on matching score calculation weight, the score of matching between the question for the target article and the preset article corresponding to the 2-tuple information, and output the matching score obtained through calculation as output of the preset matching model.

It is assumed that the text information of the question for the target article is “a game in which a little girl wearing in white journeys through mazes”. In this case, the 2-tuple information is constructed by using the text information of the question and the modal content information of each preset article in the preset article set. Then each piece of 2-tuple information is input into the preset matching model, and the preset matching model parameter is loaded as the matching score calculation weight of the preset matching model, so that the preset matching model may calculate, based on the matching score calculation weight, the score of matching between the question for the target article and the preset article corresponding to the 2-tuple information input into the preset matching model, and output the score of matching between the preset article and the question for the target article.

TABLE 1
2-tuple information and matching score thereof

| 2-tuple information | | |
|---|---|---|
| Question | Article list | Matching score |
| A game in which a little | WeChat | S (a game in which a little girl |
| girl wearing in white | | wearing in white journeys through |
| journeys through mazes | | mazes, WeChat) = 0.05 |
| A game in which a little | QQ | S (a game in which a little girl |
| girl wearing in white | | wearing in white journeys through |
| journeys through mazes | | mazes, QQ) = 0.04 |
| A game in which a little | Taobao | S (a game in which a little girl |
| girl wearing in white | | wearing in white journeys through |
| journeys through mazes | | mazes, Taobao) = 0.082 |
| A game in which a little | Baidu | S (a game in which a little girl |
| girl wearing in white | Map | wearing in white journeys through |
| journeys through mazes | | mazes, Baidu Map) = 0.12 |
| A game in which a little | Subway | S (a game in which a little girl |
| girl wearing in white | Escape | wearing in white journeys through |
| journeys through mazes | | mazes, Subway Escape) = 0.35 |
| A game in which a little | Crisis | S (a game in which a little girl |
| girl wearing in white | Action | wearing in white journeys through |
| journeys through mazes | | mazes, Crisis Action) = 0.23 |
| A game in which a little | Moji | S (a game in which a little girl |
| girl wearing in white | Weather | wearing in white journeys through |
| journeys through mazes | | mazes, Moji Weather) = 0.05 |
| A game in which a little | Himalaya | S (a game in which a little girl |
| girl wearing in white | FM | wearing in white journeys through |
| journeys through mazes | | mazes, Himalaya FM) = 0.03 |
| A game in which a little | Toutiao | S (a game in which a little girl |
| girl wearing in white | | wearing in white journeys through |
| journeys through mazes | | mazes, Toutiao) = 0.01 |
| A game in which a little | Ku6 | S (a game in which a little girl |
| girl wearing in white | Video | wearing in white journeys through |
| journeys through mazes | | mazes, Ku6 Video) = 0.11 |
| A game in which a little | Monument | S (a game in which a little girl |
| girl wearing in white | Valley | wearing in white journeys through |
| journeys through mazes | | mazes, Monument Valley) = 0.83 |
| A game in which a little | AniPop | S (a game in which a little girl |
| girl wearing in white | | wearing in white journeys through |
| journeys through mazes | | mazes, AniPop) = 0.27 |

In this embodiment, assuming that the 2-tuple information formed by using the article list included in the preset article set and the question for the target article is shown in Table 1, a corresponding matching score may be obtained after each piece of 2-tuple information is input into the preset matching model.

N preset articles are sequentially selected from the preset article set in descending order of matching scores based on the matching scores output from the preset matching model, to generate and output the article recommendation list for the question for the target article. For example, in this embodiment, a value of N may be 3. In this case, the article recommendation list that is output is as follows. 1. Monument Valley; 2. Subway Escape; and 3. AniPop.

It may be seen from the matching scores shown in Table 1 that the matching score corresponding to “Monument Valley” is 0.83, and is the highest in the matching scores of all preset articles, so that “Monument Valley” is placed first in the recommendation list. In this way, a user can obtain, based on the recommendation list, an application corresponding to the question “a game in which a little girl wearing in white journeys through mazes”.

It may be understood that in terms of statement expression, the question for the target article may be different from a question about the target article in the training sample. For example, it is assumed that the target article is “Monument Valley”, and a question about “Monument Valley” (that is, a question for the target article in the training sample) that is obtained from the community question answer platform is “a game in which a little girl wearing in white journeys through mazes”. In this case, when an obtained question of a user for the target article “Monument Valley” is “a game in which a little girl wearing in white journeys through mazes”, the question and the target article can also be matched. In addition, the question for the target article may be a combination of a plurality of keywords expressed by a user based on a feature of the target article, for example, “a girl wearing in white or journeying through mazes”.

In an implementation, to evaluate accuracy of recommending an article by using the preset matching model, the model needs to be tested offline. A format of test data of the preset matching model keeps the same as the training sample of the preset matching model. A user enters a test question (that is, the text information of the question for the target article), in natural language, that does not overlap training data, scores of matching between the test question and the plurality of preset articles in the preset article set are obtained based on the matching model parameter set and a prediction function, and article recommendation results for the test question are output in descending order of the matching scores. For example:

Question: a game in which a little girl wearing in white journeys through mazes.

Recommendation: Monument Valley, Ghosts of Memories, Doors&Rooms, Machinarium . . . ; or

Question: a combat business game for exploring an unknown world.

Recommendation: Boom Beach, Clash of Clans, League of War, Clash of Kings . . .

It may be understood that in article recommendation results for each question, a correlation between an application (that is, an article) and the given question progressively decreases with an arrangement sequence.

In an implementation, the modal content information includes at least one of introduction text information, tag information, and image display information of the preset article, and before the obtaining text information of an online question for a target article, the method further includes constructing the preset matching model based on the modal content information.

The preset matching model is used to match the text information of the question and the modal content information that are in the input 2-tuple information, and output a corresponding matching score.

The modal content information may include different types of information, for example, the introduction text information and the tag information belong to text type information, and the image display information belongs to image type information. Therefore, when the preset matching model is constructed, matching models of different modal content information need to be established based on different types of modal content information, and then a multi-modal merging matching model is established by using the matching models of different modal content information.

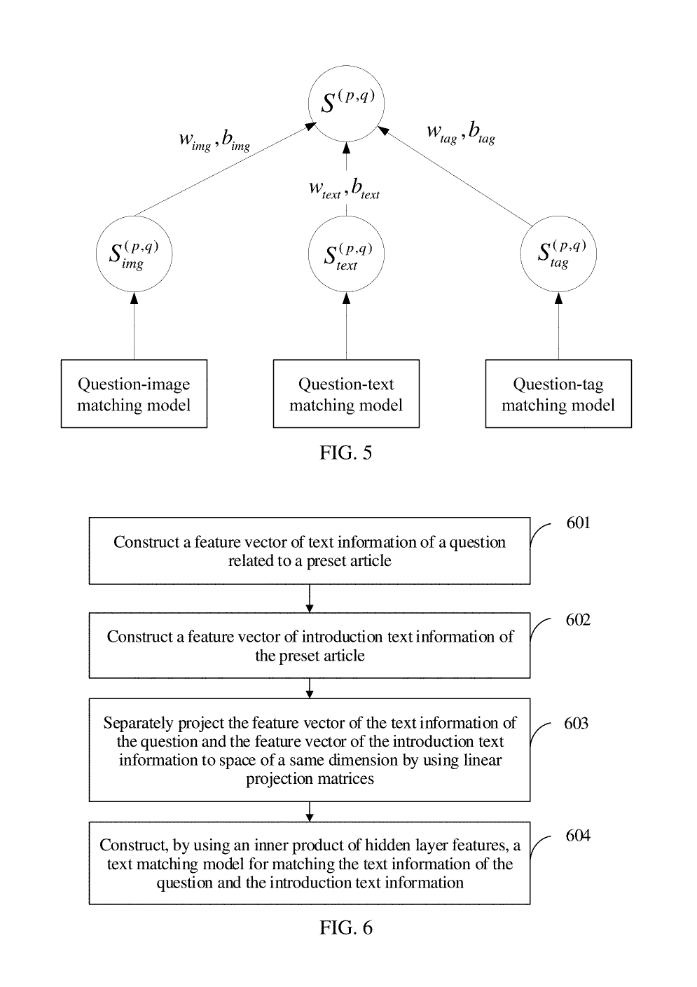

Referring to FIG. 5, in an implementation, the preset article set is denoted as P, a set of questions related to the preset article is denoted as Q, and a matching relationship between any article p∈P and any question g∈Q posed by a user is represented by a score S^{(p,q)}.

Each article may have a plurality of pieces of modal content information, and in each modality, there is a matching score of the 2-tuple information. For example, matching scores corresponding to the three pieces of modal content information, namely, the image display information, the introduction text information, and the tag information, may be respectively represented as S_{img}^{(p,q)}, Sₜₑₓₜ^{(p,q)}, and S_{tag}^{(p,q)}. Different matching scores are separately obtained by the matching models of the corresponding modal content information of the article. A comprehensive score S^{(p,q)} of matching between the given question and the article is finally obtained by using an integration function g(•), and is denoted as follows:

S^{(p,q)}=g(S_{img}^{(p,q)},Sₜₑₓₜ^{(p,q)},S_{tag}^{(p,q)};w_{img},wₜₑₓₜ,w_{tag},b_{img},bₜₑₓₜ,b_{tag})

The parameter set {w_{img},wₜₑₓₜ,w_{tag},b_{img},bₜₑₓₜ,b_{tag}}∈Θ may be obtained through model training, and Θ represents all used model parameter sets. The integration function g(•) may be any function using S_{img}^{(p,q)}, Sₜₑₓₜ^{(p,q)}, and S_{tag}^{(p,q)}as independent variables, and using a parameter in the parameter set {w_{img},wₜₑₓₜ,w_{tag},b_{img},bₜₑₓₜ,b_{tag}}∈Θ as a weight.

Referring to FIG. 6, in an implementation, if the modal content information is the introduction text information of the preset article, the constructing the preset matching model based on the modal content information includes the following steps.

Step 601: Construct a feature vector v_{qe}∈R^{m} of text information of a question related to the preset article, where R is Euclidean space, and m is a dimension of the feature vector v_{qe} of the text information of the question.

Step 602: Construct a feature vector vₜₑₓₜ∈Rⁿ of the introduction text information of the preset article, where n is a dimension of the feature vector vₜₑₓₜ of the introduction text information.

Step 603: Separately project the feature vector v_{qe} of the text information of the question and the feature vector vₜₑₓₜ of the introduction text information to space of a same dimension by using linear projection matrices L_{qe}∈R^{m×k} and Lₜₑₓₜ∈R^{n×k}.

Step 604: Construct, by using an inner product of hidden layer features, a text matching model Sₜₑₓₜ(v_{qe},vₜₑₓₜ)=<L_{qe}v_{qe},Lₜₑₓₜvₜₑₓₜ>=v^{T}_{qe}L^{T}_{qe}Lₜₑₓₜvₜₑₓₜ for matching the text information of the question and the introduction text information.

{L_{qe},Lₜₑₓₜ}∈Θ is a parameter of the text matching model for matching the text information of the question and the introduction text information, and Θ is a parameter set of the text matching model. In this embodiment, the text matching model is a bilinear model.

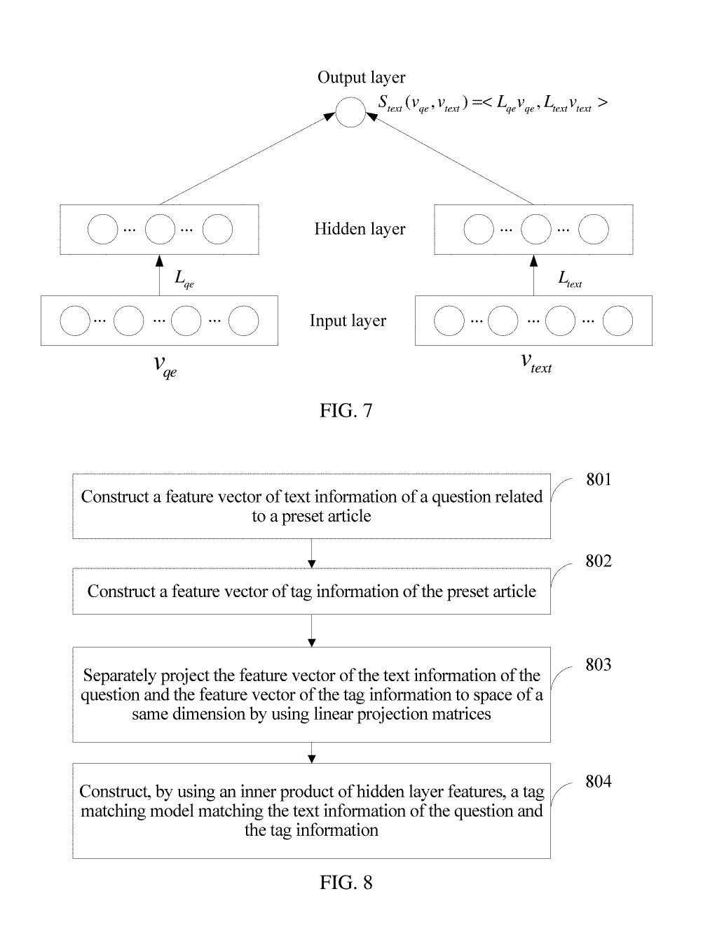

Referring to FIG. 7, the feature vector of the text information of the question is represented as v_{qe}∈R^{m} , the feature vector of the introduction text information of the article is represented as vₜₑₓₜ∈Rⁿ, and the feature vectors v_{qe}∈R^{m} and vₜₑₓₜ∈Rⁿ are used as model input; and R represents the Euclidean space. It may be understood that in the bilinear model, feature dimensions of v_{qe} and vₜₑₓₜ may be different, that is, m and n are unnecessarily equal to each other. In an embodiment, initial v_{qe},vₜₑₓₜ may be generated by using a model such as a word vector. The feature vector of the text information of the question and the feature vector of the introduction text information of the article are separately projected to the space of a same dimension by using the linear projection matrices L_{qe}∈R^{m×k} and Lₜₑₓₜ∈R^{n×k}, and then a matching correlation between the question and the article in terms of text modality is obtained by performing an inner production operation on the hidden layer features.

For the constructed 2-tuple information training sample, an optimization problem of maximizing the matching correlation may be established to calculate a bilinear mode parameter {L_{qe},Lₜₑₓₜ}∈Θ.

It may be understood that in an implementation, construction of the text matching model is not limited to use of the bilinear model, and the text matching model may be any other model that can implement text matching. For example, the text matching model for matching the text information of the question and the introduction text information may be established by using a convolutional neural network. In an embodiment, establishing, by using a convolutional neural network, the text matching model for matching the text information of the question and the introduction text information includes dividing text information of a question related to the preset article into a plurality of semantic units, and constructing a word feature vector vⁱ_{qe},i=1, . . . ,n of each semantic unit; dividing the introduction text information of the preset article into a plurality of semantic units, and constructing a word feature vector vⁱₜₑₓₜ,i=1, . . . ,m of each semantic unit; converting the text information of the question into a word feature vector representation z_{qe}=CNN_{qe}[v¹_{qe},v²_{qe}, . . . ,vⁿ_{qe}];θ_{qe}) by using a convolutional neural network CNN_{qe}(•), where θ_{qe} is a parameter of the convolutional neural network; converting the introduction text information into a word feature vector representation zₜₑₓₜ=CNNₜₑₓₜ([vₜₑₓₜ¹,vₜₑₓₜ², . . . ,vₜₑₓₜ^{m}]θₜₑₓₜ) by using a convolutional neural network CNNₜₑₓₜ(•), where θₜₑₓₜ is a parameter of the convolutional neural network; and constructing, by using a feed-forward neural network MLP(•, a text matching model Sₜₑₓₜ(z_{qe},zₜₑₓₜ)=MLP([z_{qe};zₜₑₓₜ];wₜₑₓₜ) for matching the text information of the question and the introduction text information, where wₜₑₓₜ is a parameter of the feed-forward neural network.

{θ_{qe},θₜₑₓₜ,wₜₑₓₜ}∈Θ is a parameter of the text matching model for matching the text information of the question and the introduction text information, and Θ is a parameter set of the text matching model.

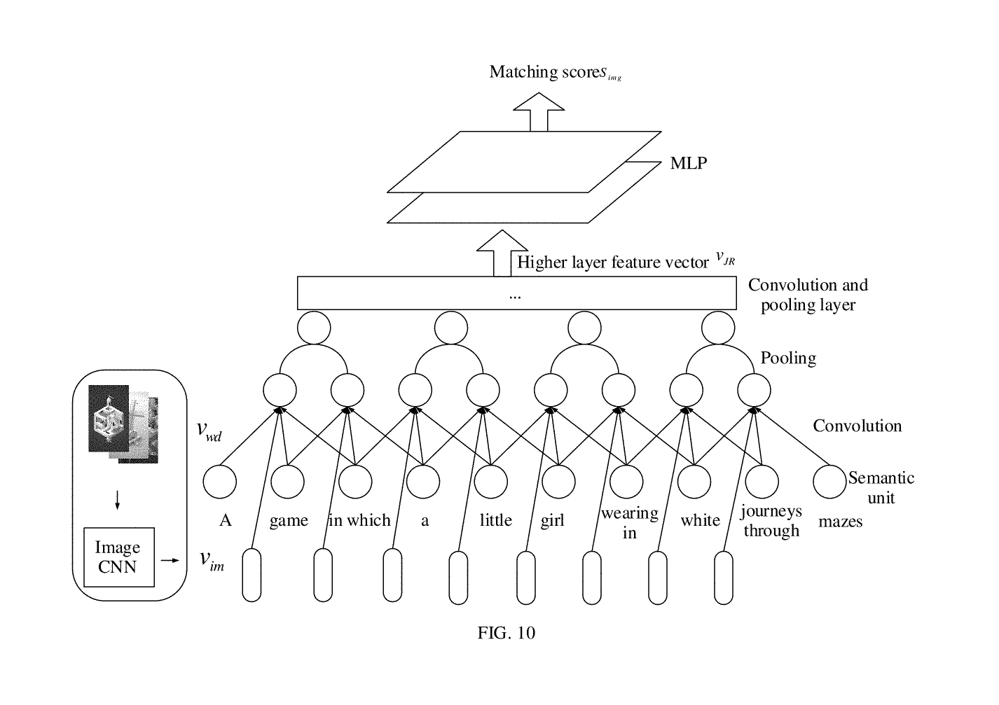

In this implementation, the convolutional neural network CNN_{qe}(•) and the feed-forward neural network MLP(•) each unnecessarily have a fixed structure. For example, the convolutional neural network may have a structure of one convolution layer+one max-pooling layer, or may have a structure of one convolution layer+one max-pooling layer+one convolution layer+one max-pooling layer . . . . The feed-forward neural network may have one layer or a plurality of layers. For data representations of the convolutional neural network CNN_{qe}(•) and the feed-forward neural network MLP(•), refer to descriptions in the embodiment shown in FIG. 10.

Referring to FIG. 8, in an implementation, if the modal content information is the tag information of the preset article, the constructing the preset matching model based on the modal content information includes the following steps.

Step 801: Construct a feature vector v_{qe}∈R^{m} of text information of a question related to the preset article, where R is Euclidean space, and m is a dimension of the feature vector v_{qe} of the text information of the question.

Step 802: Construct a feature vector v_{tag}∈Rⁿ information of the preset of article, where n is a dimension of the feature vector v_{tag} of the tag information.

Step 803: Separately project the feature vector v_{qe} of the text information of the question and the feature vector V_{tag} tag of the tag information to space of a same dimension by using linear projection matrices L_{qe}∈R^{m×k} and L_{tag}∈R^{n×k}.

Step 804: Construct, by using an inner product of hidden layer features, a tag matching model S_{tag}(v_{qe},v_{tag})=<L_{qe}v_{qe},L_{tag}v_{tag}>=v^{T}_{qe}L^{T}_{qe}L_{tag}v_{tag} matching the text information of the question and the tag information.

{L_{qe}, L_{tag}}∈Θ is a parameter of the tag matching model matching the text information of the question and the tag information, and Θ is a parameter set of the tag matching model. In this embodiment, the tag matching model is a bilinear model.

It may be understood that matching between an article tag and a question may also be implemented by using a bilinear model, and an embodiment implementation is maximizing an equation based on the 2-tuple information training sample:

S_{tag}(v_{qe},v_{tag})=<L_{qe}v_{qe},L_{tag}v_{tag}>=v^{T}_{qe}L^{T}_{qe}L_{tag}v_{tag}

The parameter {L_{qe},L_{tag}}∈Θ may be calculated by using a same method as that in each of implementations shown in FIG. 6 and FIG. 7.

It may be understood that in an implementation, the tag matching model may also be constructed by using a convolutional neural network, and this embodiment includes dividing text information of a question related to the preset article into a plurality of semantic units, and constructing a word feature vector vⁱ_{qe},i=1, . . . ,n of each semantic unit; dividing the tag information of the preset article into a plurality of semantic units, and constructing a word feature vector vⁱ_{tag},i=1, . . ., m of each semantic unit; converting the text information of the question into a word feature vector representation z_{qe}=CNN_{qe}([v¹_{qe},v²_{qe}, . . . ,vⁿ_{qe}];θ_{qe}) by using a convolutional neural network CNN_{qe}(•), where θ_{qe} is a parameter of the convolutional neural network; converting the tag information into a word feature vector representation z_{tag}=CNN_{tag}([v_{tag}¹,v_{tag}², . . . ,v_{tag}^{m}];θ_{tag}) by using a convolutional neural network CNN_{tag}(•), where θ_{tag} is a parameter of the convolutional neural network; and constructing, by using a feed-forward neural network MLP(•), a tag matching model S_{tag}(z_{qe},z_{tag})=MLP([z_{qe};z_{tag}];w_{tag}) matching the text information of the question and the tag information, where w_{tag} is a parameter of the feed-forward neural network.

{θ_{qe},θ_{tag},w_{tag}}∈Θ is a parameter of the tag matching model matching the text information of the question and the tag information, and Θ is a parameter set of the tag matching model.

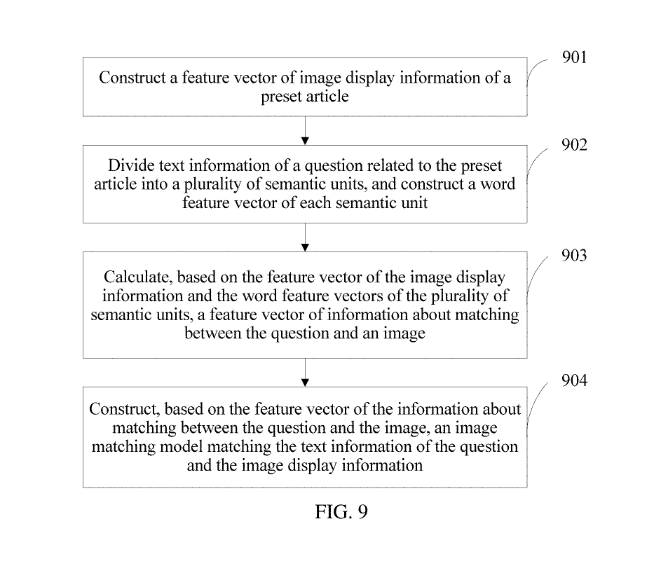

In this implementation, the convolutional neural network CNN_{qe}(•) and the feed-forward neural network MLP(•) each unnecessarily have a fixed structure. For example, the convolutional neural network may have a structure of one convolution layer+one max-pooling layer, or may have a structure of one convolution layer+one max-pooling layer+one convolution layer+one max-pooling layer . . . . The feed-forward neural network may have one layer or a plurality of layers. For data representations of the convolutional neural network CNN_{qe}(•) and the feed-forward neural network MLP(•), refer to descriptions in the embodiment shown in FIG. 10. Referring to FIG. 9, in an implementation, if the modal content information is the image display information of the preset article, the constructing the preset matching model based on the modal content information includes the following steps.

Step 901: Construct a feature vector vᵢₘ of the image display information of the preset article.

Step 902: Divide text information of a question related to the preset article into a plurality of semantic units, and construct a word feature vector vⁱ_{wd} of each semantic unit.

Step 903: Calculate, based on the feature vector vᵢₘ of the image display information and the word feature vectors vⁱ_{wd} of the plurality of semantic units, a feature vector v_{JR} of information about matching between the question and an image.

Step 904: Construct, based on the feature vector v_{JR} of the information about matching between the question and the image, an image matching model S_{img}=wₛ(σ(wₘ(v_{JR})+bₘ))+bₛ matching the text information of the question and the image display information, where {wₘ,bₘ}∈Θ is a hidden layer parameter, {wₛ,bₛ}∈Θ is an output layer parameter and is used to calculate a final matching score S_{img}, and Θ is a parameter set of the image matching model.

Referring to FIG. 10, input image display information and text information of a question in natural language are matched by using a convolutional neural network (CNN), and a matching score value is output. The network model is referred to as m-CNN for short. The network model m-CNN includes three parts: an image CNN, a matching CNN and an MLP. The image CNN and is used to generate a feature representation of an article in terms of image, and a process of generating the feature representation may be represented as the following formula:

vᵢₘ=σ(Wᵢₘ(CNNᵢₘ(I))+bᵢₘ),

I is a given input image; vᵢₘ is an image feature vector that is output; CNNᵢₘ(•) may be considered as a convolutional neural network operation, and output is a feature vector with a fixed length; Wᵢₘ,bᵢₘ are respectively a projection matrix and an offset item, and {Wᵢₘ,bᵢₘ}∈Θ; σ(•) is an activation function, and a Sigmoid function or ReLU may be selected.

The matching CNN is also referred to as a matching CNN and is a convolutional neural network model mainly used for feature matching. Input is an image feature vector vᵢₘ and a word feature vector vⁱ_{wd}. The word feature vector may be obtained by using a word vector (word embedding) or a bag of words. It may be seen from FIG. 10 that the matching CNN first divides words into different semantic units, and then uses the image feature vᵢₘ to interact with each semantic unit, and generates a common higher layer semantic representation. In an embodiment, a word-level semantic unit is used herein. For a convolution unit in a multi-modal convolutional neural network, model input may be written as follows:

\vec{v}₍₀₎ⁱ [symbol] v_{wd}ⁱ∥v_{wd}ⁱ⁺¹∥ . . . ∥v_{wd}^{i+k}^{ᵣₚ}⁻¹∥v_{img}

vⁱ_{wd} represents an ⁱth word in an interrogative sentence in natural language, kᵣₚ represents a quantity of words obtained by the convolution unit, and a symbol ∥ represents splicing of vector representations. Therefore, input \vec{v}₍₀₎ⁱ of the ⁱth convolution unit is obtained. A convolution process of the matching CNN is as follows:

vi_{(l,f)}ⁱ [symbol] σ(w_{(l,f)}\vec{v}₍ₗ₋₁₎ⁱ+b_{(l,f)})

A max pooling process in the matching CNN is expressed as follows:

v_{(l+1,f)}ⁱ=max(v_{(l,f)}²ⁱ,v_{(l,f)}²ⁱ⁺¹)

The corner mark (l, f) represents an ^{l}th layer and an f feature mapping block (Feature Map), and a corresponding parameter of the matching CNN is {w_{(l,f)},b_{(l,f)}}∈Θ. Output of the matching CNN is a vector v_{JR} embedded with a higher layer feature of information about matching between the question and an image.

The MLP represents a multilayer perceptron. The joint feature representation v_{JR} is used as input of the MLP, and a final image-question matching score result can be output and is calculated by using the following formula:

S_{img}=wₛ(σ(wₘ(v_{JR})+bₘ))+bₛ

It may be learned that an MLP with two layers is used herein, {wₘ,bₘ}∈Θ represents a hidden layer parameter, and {wₛ,bₛ}∈Θ to calculate a final matching score S_{img}.

The image CNN, the matching CNN, and the MLP jointly form the multi-modal convolutional neural network m-CNN.

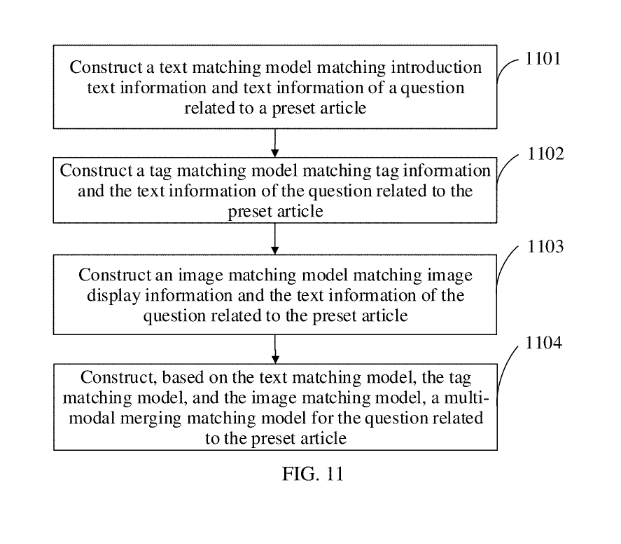

Referring to FIG. 11, in an implementation, if the modal content information includes the introduction text information, the tag information, and the image display information of the preset article, the constructing the preset matching model based on the modal content information includes the following steps.

Step 1101: Construct a text matching model Sₜₑₓₜ^{(p,q)} matching the introduction text information and text information of a question related to the preset article.

Step 1102: Construct a tag matching model S_{tag}^{(p,q)} matching the tag information and the text information of the question related to the preset article.

Step 1103: Construct an image matching model S_{img}^{(p,q)} matching the image display information and the text information of the question related to the preset article.

Step 1104: Construct, based on the text matching model Sₜₑₓₜ^{(p,q)}, the tag matching model S_{tag}^{(p,q)}, and the image matching model S_{img}^{(p,q)}, a multi-modal merging matching model for the question related to the preset article:

$${arg max}_{Θ} S ( Θ ) = {argmax}_{Θ} {\sum }_{< p , q > ∈ D} g ( {S}_{img}^{( p , q )} , {S}_{text}^{( p , q )} , {S}_{tag}^{( p , q )} ; Θ ) + λΩ ( Θ )$$

It may be understood that for embodiment methods for constructing the text matching model Sₜₑₓₜ^{(p,q)}, the tag matching model S_{tag}^{(p,q)}, and the image matching model S_{img}^{(p,q)}, refer to related descriptions in the embodiments shown in FIG. 6 to FIG. 9. Details are not described herein again. An end-to-end multi-modal merging matching model may be obtained by fusing the image matching model S_{img}^{(p,q)}, the text matching model Sₜₑₓₜ^{(p,q)}, and the tag matching model S_{tag}^{(p,q)} in a multi-modal merging matching model frame provided in FIG. 5, to jointly optimize all model parameters in the parameter set Θ.

Θ is a parameter set of the multi-modal merging matching model, D is a 2-tuple information training sample set of the preset article, Ω(•) is a regularization item and is used to avoid model over-fitting that may be caused by excessive parameters, and λ is a hyperparameter and is used to balance functions of correlation matching and the regularization item in an optimization problem.

For the foregoing multi-modal merging matching model, the parameter set Θ is calculated to maximize a correlation, in the training sample set D, between the question and text information of the target article, so that scores of matching between the question and different articles in the training sample set may be calculated. Advantages of using the multi-modal merging matching model lie in the following. Contribution of different modalities to an overall matching model can be adaptively adjusted, and a same target function is used to optimize a multi-modal feature to generate a model, such as an image CNN or a word vector model, to better adapt to a matching task.

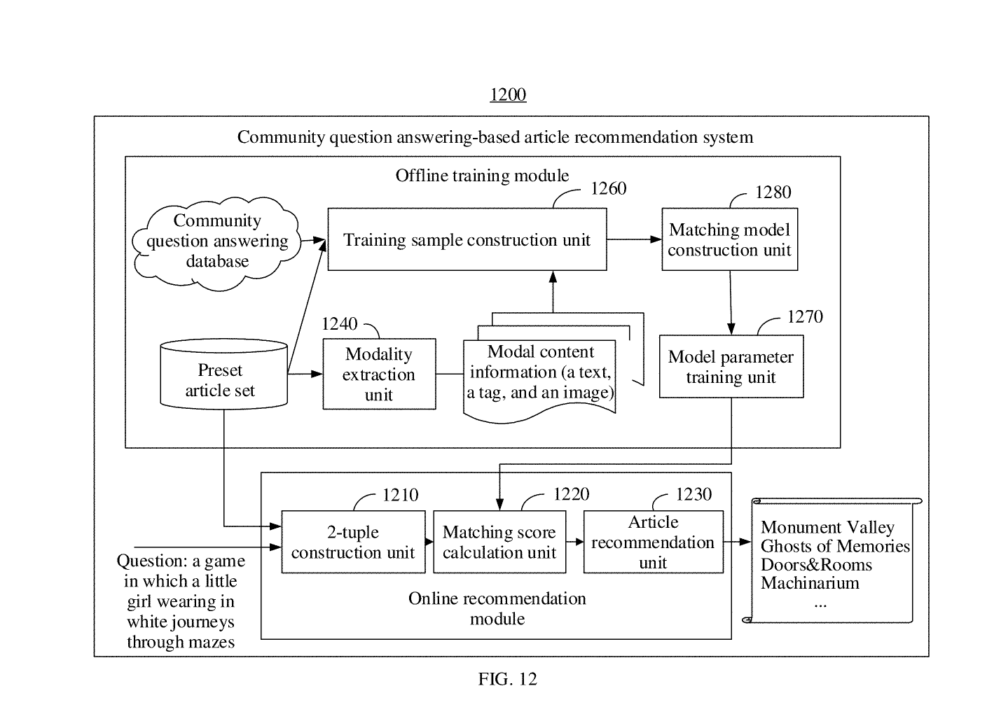

Referring to FIG. 12, an embodiment of the present disclosure provides a community question answering-based article recommendation system 1200, including a 2-tuple construction unit 1210 configured to obtain text information of a question for a target article, and separately construct 2-tuple information by using the text information of the question and modal content information of each of a plurality of preset articles in a preset article set, where the modal content information is used to represent a feature of the preset article, and the 2-tuple information includes the text information of the question and the modal content information of the preset article; a matching score calculation unit 1220 configured to input each piece of 2-tuple information into a preset matching model, and calculate, with reference to a preset matching model parameter, a score of matching between each preset article and the question, where the preset matching model is used to match each preset article in the preset article set and the question for the target article, and output a corresponding matching score; and an article recommendation unit 1230, configured to output an article recommendation list for the question for the target article based on the scores of matching between the plurality of preset articles and the question for the target article.

In the article recommendation system 1200, the 2-tuple information is constructed by using the text information of the question and the modal content information of the article, and the 2-tuple information is used as input of the preset matching model. Then the scores of matching between the question and the plurality of articles in the preset article set are calculated with reference to the preset matching model parameter, and the article recommendation list is output based on the matching scores. The preset matching model parameter may be obtained by training a large quantity of training samples, thereby helping improve article recommendation precision.

In an implementation, the matching score calculation unit 1220 is further configured to input, into the preset matching model, modal content information of a preset article and text information of the question for the target article that are corresponding to each piece of 2-tuple information; load the preset matching model parameter as a matching score calculation weight of the preset matching model; and calculate, based on the matching score calculation weight, the score of matching between the preset article and the question for the target article, and use the matching score obtained through calculation as output of the preset matching model.

After the preset matching model is trained by using the 2-tuple information training sample, the preset matching model parameter corresponding to the training sample may be obtained. The preset matching model parameter is loaded as a current parameter of the preset matching model, so that when the 2-tuple information is input into the preset matching model, the preset matching model may calculate, based on the preset matching model parameter, the score of matching between the question for the target article and the preset article corresponding to the 2-tuple information, and output the matching score obtained through calculation as output of the preset matching model.

In an implementation, the article recommendation system 1200 further includes a modality extraction unit 1240 configured to extract the modal content information of the preset article in the preset article set, and extract, from a community question answering database based on a name of the preset article, text information of a question related to the preset article; a training sample construction unit 1260, configured to construct a 2-tuple information training sample for the preset article with reference to the modal content information of the preset article and the text information of the question related to the preset article; and a model parameter training unit 1270, configured to input the 2-tuple information training sample into the preset matching model for training, to obtain the corresponding preset matching model parameter.

The preset matching model parameter is used to calculate the score of matching between each preset article and the online question for the target article.

The text information of the question related to the preset article is extracted from the community question answering database, and the 2-tuple information training sample for the preset article is constructed. The community question answering database usually includes a large quantity of question-answer combinations. Therefore, richness of training samples can be ensured, thereby helping improve performance of the matching model and optimizing the matching model parameter, and further improving article recommendation precision.

In an implementation, the article recommendation system 1200 further includes a matching model construction unit 1280 configured to construct the preset matching model based on the modal content information. The preset matching model is used to match the text information of the question and the modal content information that are in the input 2-tuple information, and output a corresponding matching score.

In this embodiment, the 2-tuple construction unit 1210, the matching score calculation unit 1220, and the article recommendation unit 1230 form an online recommendation module of the article recommendation system 1200. The online recommendation module is configured to calculate, based on the preset matching model and with reference to a matching model parameter obtained through training, a score of matching between each preset article in the preset article set and a natural statement question entered by a user; and output an article recommendation list based on the matching score. The modality extraction unit 1240, a correlation pair construction unit 1250, the training sample construction unit 1260, the model parameter training unit 1270, and the matching model construction unit 1280 form an offline training module of the article recommendation system 1200. The offline training module is configured to construct a training sample to train the preset matching model, and output a corresponding matching model parameter to the online recommendation module.

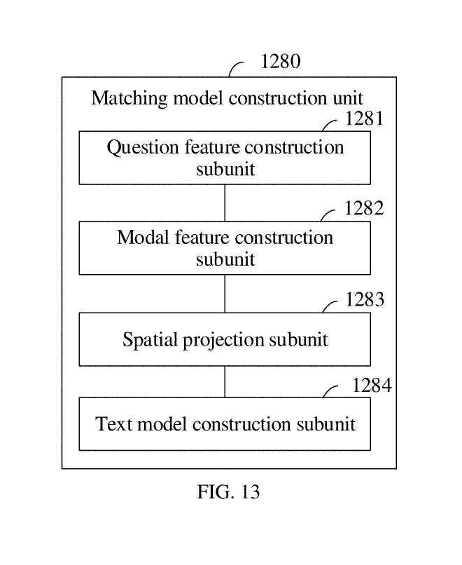

Referring to FIG. 13, in an implementation, the matching model construction unit 1280 includes a question feature construction subunit 1281 configured to construct a feature vector v_{qe}∈R^{m} of text information of a question related to the preset article, where R is Euclidean space, and m is a dimension of the feature vector v_{qe} of the text information of the question; a modal feature construction subunit 1282, configured to construct a feature vector vₜₑₓₜ∈Rⁿ of introduction text information of the preset article, where n is a dimension of the feature vector vₜₑₓₜ of the introduction text information; a spatial projection subunit 1283, configured to separately project the feature vector v_{qe} of the text information of the question and the feature vector vₜₑₓₜ of the introduction text information to space of a same dimension by using linear projection matrices L_{qe}∈R^{m×k} and Lₜₑₓₜ∈R^{n×k}; and a text model construction subunit 1284, configured to construct, by using an inner product of hidden layer features, a text matching model for matching the text information of the question and the introduction text information:

Sₜₑₓₜ(v_{qe},vₜₑₓₜ)=<L_{qe}v_{qe},Lₜₑₓₜvₜₑₓₜ>=v^{T}_{qe}L^{T}_{qe}Lₜₑₓₜvₜₑₓₜ

{L_{qe},Lₜₑₓₜ}∈Θ is a parameter of the text matching model for matching the text information of the question and the introduction text information, and Θ is a parameter set of the text matching model.

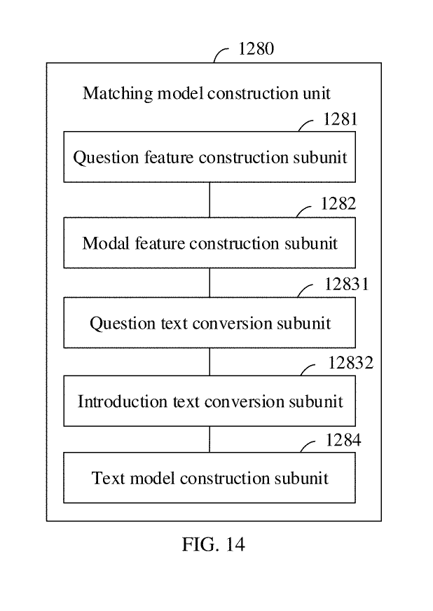

Referring to FIG. 14, in an implementation, the matching model construction unit 1280 includes a question feature construction subunit 1281 configured to divide text information of a question related to the preset article into a plurality of semantic units, and construct a word feature vector vⁱ_{qe},i=1, . . . ,n of each semantic unit; a modal feature construction subunit 1282 configured to divide introduction text information of the preset article into a plurality of semantic units, and construct a word feature vector vₜₑₓₜⁱ,i=1, . . . ,m of each semantic unit; a question text conversion subunit 12831, configured to convert the text information of the question into a word feature vector representation z_{qe}=CNN_{qe}([v¹_{qe},v²_{qe}, . . . ,vⁿ_{qe}];θ_{qe}) by using a convolutional neural network CNN_{qe}(•), where θ_{qe} a parameter of the convolutional neural network; an introduction text conversion subunit 12832, configured to convert the introduction text information into a word feature vector representation zₜₑₓₜ=CNNₜₑₓₜ ([vₜₑₓₜ¹,vₜₑₓₜ², . . . ,vₜₑₓₜ^{m}];θₜₑₓₜ) by using a convolutional neural network CNNₜₑₓₜ(•), where θₜₑₓₜ is a parameter of the convolutional neural network; and a text model construction subunit 1284, configured to construct, by using a feed-forward neural network MLP(•), a text matching model Sₜₑₓₜ(z_{qe},zₜₑₓₜ)=MLP([z_{qe};zₜₑₓₜ];wₜₑₓₜ) for matching the text information of the question and the introduction text information, where wₜₑₓₜ is a parameter of the feed-forward neural network.

{θ_{qe},θₜₑₓₜ,wₜₑₓₜ}∈Θ is a parameter of the text matching model for matching the text information of the question and the introduction text information, and Θ is a parameter set of the text matching model.

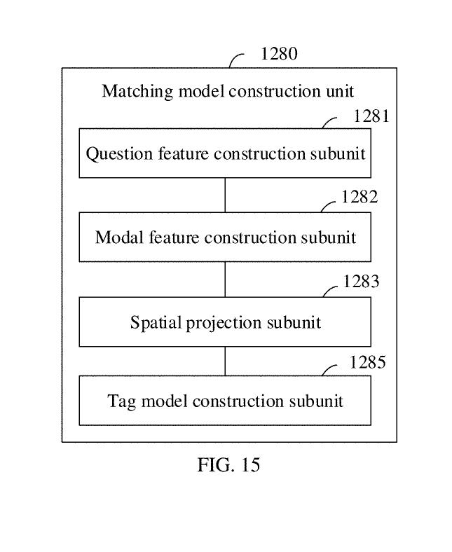

Referring to FIG. 15, in an implementation, the matching model construction unit 1280 includes a question feature construction subunit 1281 configured to construct a feature vector v_{qe}∈R^{m} of text information of a question related to the preset article, where R is Euclidean space, and m is a dimension of the feature vector v_{qe} of the text information of the question; a modal feature construction subunit 1282, configured to construct a feature vector v_{tag}∈Rⁿ of tag information of the preset article, where n is a dimension of the feature vector v_{tag} of the tag information; a spatial projection subunit 1283, configured to separately project the feature vector v_{qe} of the text information of the question and the feature vector v_{tag} of the tag information to space of a same dimension by using linear projection matrices L_{qe}∈R^{m×k} and L_{tag}∈R^{n×k}; and a tag model construction subunit 1285, configured to construct, by using an inner product of hidden layer features, a tag matching model matching the text information of the question and the tag information:

S_{tag}(v_{qe},v_{tag})=<L_{qe}v_{qe},L_{tag}v_{tag}>=v^{T}_{qe}L^{T}_{qe}L_{tag}v_{tag},

{L_{qe},L_{tag}}∈Θ is a parameter of the tag matching model matching the text information of the question and the tag information, and Θ is a parameter set of the tag matching model.

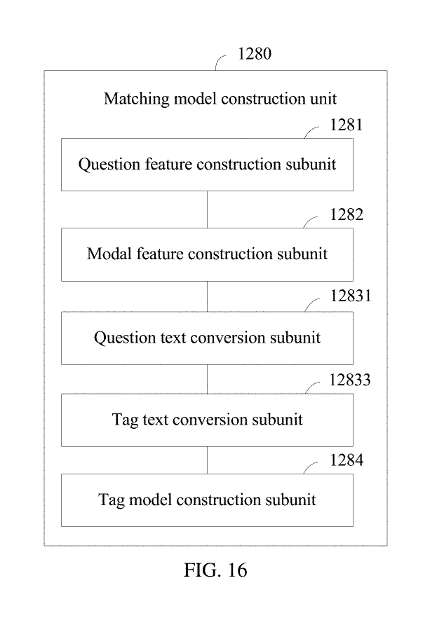

Referring to FIG. 16, in an implementation, the matching model construction unit 1280 includes a question feature construction subunit 1281 configured to divide text information of a question related to the preset article into a plurality of semantic units, and construct a word feature vector vⁱ_{qe},i=1, . . . ,n of each semantic unit; a modal feature construction subunit 1282 configured to divide tag information of the preset article into a plurality of semantic units, and construct a word feature vector vⁱ_{tag},i=1, . . . ,m of each semantic unit; a question text conversion subunit 12831, configured to convert the text information of the question into a word feature vector representation z_{qe}=CNN_{qe}([v_{qe}¹,v_{qe}², . . . ,v_{qe}ⁿ];θ_{qe}) by using a convolutional neural network CNN_{qe}(•), where θ_{qe} is a parameter of the convolutional neural network; a tag text conversion subunit 12833, configured to convert the tag information into a word feature vector representation z_{tag}=CNN_{qe}([v_{qe}¹,v_{qe}², . . . ,v_{qe}ⁿ];θ_{qe}) by using a convolutional neural network CNN_{tag}(•), where θ_{tag} is a parameter of the convolutional neural network; and a tag model construction subunit 1285, configured to construct, by using a feed-forward neural network MLP(•), a tag matching model S_{tag}(z_{qe},z_{tag})=MLP([z_{qe};z_{tag}];w_{tag}) matching the text information of the question and the tag information, where w_{tag} is a parameter of the feed-forward neural network.

{θ_{qe},θ_{tag},w_{tag}}∈Θ is a parameter of the tag matching model matching the text information of the question and the tag information, and Θ is a parameter set of the tag matching model.

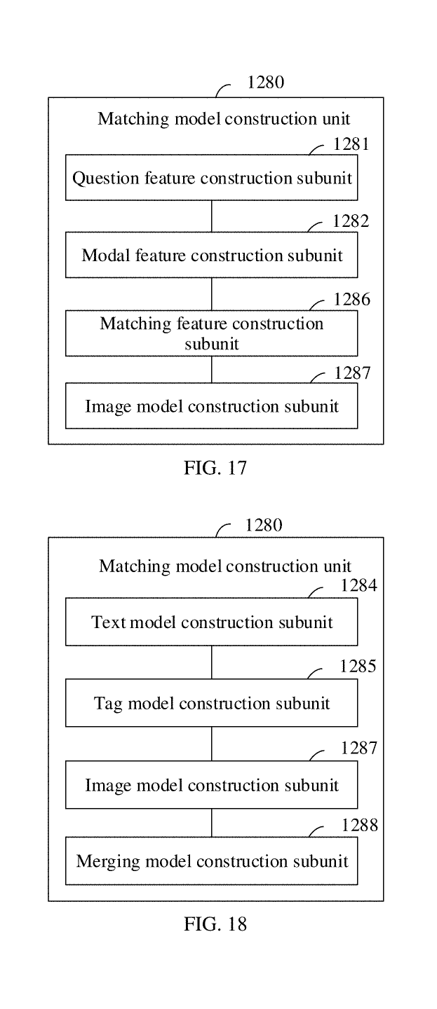

Referring to FIG. 17, in an implementation, the matching model construction unit 1280 includes a question feature construction subunit 1281 configured to divide text information of a question related to the preset article into a plurality of semantic units, and construct a word feature vector vⁱ_{wd} of each semantic unit; a modal feature construction subunit 1282, configured to construct a feature vector vᵢₘ of image display information of the preset article; a matching feature construction subunit 1286, configured to calculate, based on the feature vector vᵢₘ of the image display information and the word feature vectors vⁱ_{wd} of the plurality of semantic units, a feature vector v_{JR} of information about matching between the question and an image; and an image model construction subunit 1287, configured to construct, based on the feature vector v_{JR} of the information about matching between the question and the image, an image matching model S_{img}=wₛ(σ(wₘ(v_{JR})+bₘ))+bₛ matching the text information of the question and the image display information, where {wₘ,bₘ}∈Θ is a hidden layer parameter, {wₛ,bₛ}∈Θ is an output layer parameter and is used to calculate a final matching score S_{img}, and Θ is a parameter set of the image matching model.

Referring to FIG. 18, in an implementation, the matching model construction unit 1280 includes a text model construction subunit 1284 configured to construct a text matching model Sₜₑₓₜ^{(p,q)} matching the introduction text information and text information of a question related to the preset article; a tag model construction subunit 1285, configured to construct a tag matching model S_{tag}^{(p,q)} matching the tag information and the text information of the question related to the preset article; an image model construction subunit 1287, configured to construct an image matching model S_{img}^{(p,q)} matching the image display information and the text information of the question related to the preset article; and a merging model construction subunit 1288, configured to construct, based on the text matching model Sₜₑₓₜ^{(p,q)}, the tag matching model S_{tag}^{(p,q)}, and the image matching model S_{img}^{(p,q)}, a multi-modal merging matching model for the question related to the preset article:

$${arg max}_{Θ} S ( Θ ) = {argmax}_{Θ} {\sum }_{< p , q > ∈ D} g ( {S}_{img}^{( p , q )} , {S}_{text}^{( p , q )} , {S}_{tag}^{( p , q )} ; Θ ) + λΩ ( Θ )$$

Θ is a parameter set of the multi-modal merging matching model, D is a 2-tuple information training sample set of the preset article, Ω(•) is a regularization item and is used to avoid model over-fitting that may be caused by excessive parameters, and λ is a hyperparameter and is used to balance functions of correlation matching and the regularization item in an optimization problem.

The multi-modal merging matching model matching the question and the article is established, so that the article recommendation method can be applied to an application scenario in which users are diversified and a requirement and an intention of a user are ambiguous. Merging of a plurality of pieces of modal content information helps improve article recommendation precision in the application scenario in which users are diversified and a requirement and an intention of a user are ambiguous.

It may be understood that for functions of component units of the article recommendation system 1200 and an embodiment implementation of the functions, refer to related descriptions in the method embodiments shown in FIG. 1 to FIG. 11. Details are not described herein again.

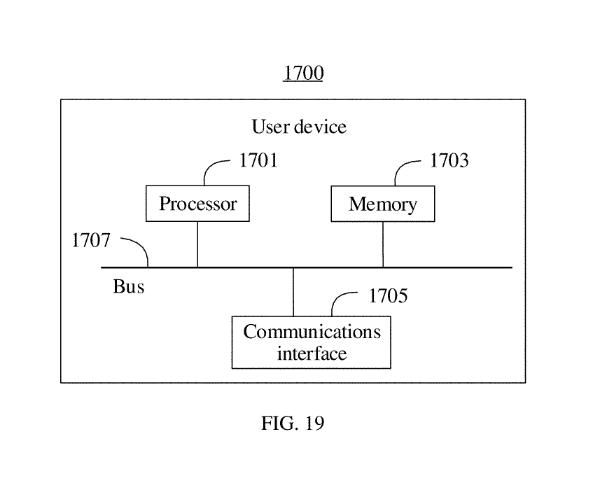

Referring to FIG. 19, an embodiment of the present disclosure provides user device 1700, including at least one processor 1701, a memory 1703, a communications interface 1705, and a bus 1707. The at least one processor 1701, the memory 1703, and the communications interface 1705 are connected and communicate with each other by using the bus 1707. The memory 1703 is configured to store executable program code. The processor 1701 is configured to invoke the executable program code stored in the memory 1703 and perform the following operations including obtaining text information of a question for a target article, and constructing 2-tuple information by using the text information of the question and modal content information of each of a plurality of preset articles in a preset article set, where the modal content information is used to represent a feature of the preset article, and the 2-tuple information includes the text information of the question and the modal content information of the preset article; inputting each piece of 2-tuple information into a preset matching model, and calculating, with reference to a preset matching model parameter, a score of matching between each preset article and the question, where the preset matching model is used to match each preset article in the preset article set and the question for the target article, and output a corresponding matching score; and outputting an article recommendation list for the question for the target article based on the scores of matching between the plurality of preset articles and the question for the target article.

The 2-tuple information is constructed by using the text information of the question and the modal content information of the article, and the 2-tuple information is used as input of the preset matching model. Then the scores of matching between the question and the plurality of articles in the preset article set are calculated with reference to the preset matching model parameter, and the article recommendation list is output based on the matching scores. The preset matching model parameter may be obtained by training a large quantity of training samples, thereby helping improve article recommendation precision.

In an implementation, the inputting each piece of 2-tuple information into a preset matching model, and calculating, with reference to a preset matching model parameter, a score of matching between each preset article and the question includes inputting, into the preset matching model, modal content information of a preset article and text information of the question for the target article that are corresponding to each piece of 2-tuple information; loading the preset matching model parameter as a matching score calculation weight of the preset matching model; and calculating, based on the matching score calculation weight, the score of matching between the preset article and the question for the target article, and using the matching score obtained through calculation as output of the preset matching model.

After the preset matching model is trained by using the 2-tuple information training sample, the preset matching model parameter corresponding to the training sample may be obtained. The preset matching model parameter is loaded as a current parameter of the preset matching model, so that when the 2-tuple information is input into the preset matching model, the preset matching model may calculate, based on the preset matching model parameter, the score of matching between the question for the target article and the preset article corresponding to the 2-tuple information, and output the matching score obtained through calculation as output of the preset matching model.

In an implementation, before the obtaining text information of a question for a target article, the operation further includes extracting the modal content information of the preset article in the preset article set, and extracting, from a community question answering database based on a name of the preset article, text information of a question related to the preset article; constructing a 2-tuple information training sample for the preset article with reference to the modal content information of the preset article and the text information of the question related to the preset article; and inputting the 2-tuple information training sample into the preset matching model for training, to obtain the corresponding preset matching model parameter.

The preset matching model parameter is used to calculate the score of matching between each preset article and the online question for the target article.

The text information of the question related to the preset article is extracted from the community question answering database, and the 2-tuple information training sample for the preset article is constructed. The community question answering database usually includes a large quantity of question-answer combinations. Therefore, richness of training samples can be ensured, thereby helping improve performance of the matching model and optimizing the matching model parameter, and further improving article recommendation precision.

In an implementation, the modal content information includes at least one of introduction text information, tag information, and image display information of the preset article, and before the obtaining text information of an online question for a target article, the operation further includes constructing the preset matching model based on the modal content information.

The preset matching model is used to match the text information of the question and the modal content information that are in the input 2-tuple information, and output a corresponding matching score.

In an implementation, if the modal content information is the introduction text information of the preset article, the constructing the preset matching model based on the modal content information includes constructing a feature vector v_{qe}∈R^{m} of text information of a question related to the preset article, where R is Euclidean space, and m is a dimension of the feature vector v_{qe} of the text information of the question; constructing a feature vector vₜₑₓₜ∈Rⁿ of the introduction text information of the preset article, where n is a dimension of the feature vector vₜₑₓₜ of the introduction text information; separately projecting the feature vector v_{qe} of the text information of the question and the feature vector vₜₑₓₜ of the introduction text information to space of a same dimension by using linear projection matrices L_{qe}∈R^{m×k} and Lₜₑₓₜ∈R^{n×k}; and constructing, by using an inner product of hidden layer features, a text matching model Sₜₑₓₜ(v_{qe},vₜₑₓₜ)=<L_{qe}v_{qe},Lₜₑₓₜvₜₑₓₜ>=v^{T}_{qe}L^{T}_{qe}Lₜₑₓₜvₜₑₓₜ for matching the text information of the question and the introduction text information.

{L_{qe},Lₜₑₓₜ}∈Θ is a parameter of the text matching model for matching the text information of the question and the introduction text information, and Θ is a parameter set of the text matching model.

In an implementation, if the modal content information is the tag information of the preset article, the constructing the preset matching model based on the modal content information includes constructing a feature vector v_{qe}∈R^{m} of text information of a question related to the preset article, where R is Euclidean space, and m is a dimension of the feature vector v_{qe} of the text information of the question; constructing a feature vector v_{tag}∈Rⁿ of the tag information of the preset article, where n is a dimension of the feature vector v_{tag} of the tag information; separately projecting the feature vector v_{qe} of the text information of the question and the feature vector v_{tag} of the tag information to space of a same dimension by using linear projection matrices L_{qe}∈R^{m×k} and L_{tag}∈R^{n×k}; and constructing, by using an inner product of hidden layer features, a tag matching model S_{tag}(v_{qe},v_{tag})=<L_{qe}v_{qe},L_{tag}v_{tag}>=v^{T}_{qe}L^{T}_{qe}L_{tag}v_{tag} matching the text information of the question and the tag information.

{L_{qe},L_{tag}}∈Θ is a parameter of the tag matching model matching the text information of the question and the tag information, and Θ is a parameter set of the tag matching model.

In an implementation, if the modal content information is the image display information of the preset article, the constructing the preset matching model based on the modal content information includes constructing a feature vector vᵢₘ of the image display information of the preset article; dividing text information of a question related to the preset article into a plurality of semantic units, and constructing a word feature vector vⁱ_{wd} of each semantic unit; calculating, based on the feature vector vᵢₘ of the image display information and the word feature vectors of the plurality of semantic units, a feature vector v_{JR} of information about matching between the question and an image; and constructing, based on the feature vector v_{JR} of the information about matching between the question and the image, an image matching model S_{img}=wₛ(σ(wₘ(v_{JR})+bₘ))+bₛ matching the text information of the question and the image display information, where {wₘ,bₘ}∈Θ is a hidden layer parameter, {wₛ,bₛ}∈Θ is an output layer parameter and is used to calculate a final matching score S_{img}, and Θ is a parameter set of the image matching model.

In an implementation, if the modal content information includes the introduction text information, the tag information, and the image display information of the preset article, the constructing the preset matching model based on the modal content information includes constructing a text matching model Sₜₑₓₜ^{(p,q)} matching the introduction text information and text information of a question related to the preset article; constructing a tag matching model S_{tag}^{(p,q)} matching the tag information and the text information of the question related to the preset article; constructing an image matching model S_{img}^{(p,q)} matching the image display information and the text information of the question related to the preset article; and constructing, based on the text matching model Sₜₑₓₜ^{(p,q)}, the tag matching model S_{tag}^{(p,q)}, and the image matching model S_{img}^{(p,q)}, a multi-modal merging matching model for the question related to the preset article:

$${arg max}_{Θ} S ( Θ ) = {argmax}_{Θ} {\sum }_{< p , q > ∈ D} g ( {S}_{img}^{( p , q )} , {S}_{text}^{( p , q )} , {S}_{tag}^{( p , q )} ; Θ ) + λΩ ( Θ )$$

Θ is a parameter set of the multi-modal merging matching model, D is a 2-tuple information training sample set of the preset article, Ω(•) is a regularization item and is used to avoid model over-fitting that may be caused by excessive parameters, and λ is a hyperparameter and is used to balance functions of correlation matching and the regularization item in an optimization problem.

The multi-modal merging matching model matching the question and the article is established, so that the article recommendation method can be applied to an application scenario in which users are diversified and a requirement and an intention of a user are ambiguous. In addition, article related knowledge is obtained from a community question answering, and a recommendation result having a high correlation with a question in natural language is automatically generated. Therefore, complex steps used during article selection can be reduced, thereby improving article recommendation accuracy while improving user experience.

It may be understood that for embodiment steps of operations performed by the processor 1701 and implementation of the operations, refer to related descriptions in the method embodiments shown in FIG. 1 to FIG. 11. Details are not described herein again.

In the embodiments of the present disclosure, a community question answering is associated with article recommendation, to construct an article recommendation system that supports user diversification and ambiguous intention interaction. Compared with a conventional system, in the article recommendation system, article related knowledge is obtained from a community question answering, and a recommendation result having a high correlation with a question in natural language is automatically generated. Therefore, complex steps used during article selection can be reduced, thereby improving article recommendation accuracy while improving user experience.

What is claimed is:

1. A community question answering-based article recommendation method, comprising:
obtaining text information of a question for a target article;
constructing 2-tuple information using the text information of the question and modal content information of each of a plurality of preset articles in a preset article set, wherein the target article is any preset article of the preset articles, wherein the modal content information represents a feature of each of the preset articles, and wherein the 2-tuple information comprises the text information of the question and the modal content information of the preset article;
inputting each piece of the 2-tuple information into a preset matching model; and
calculating, based on a preset matching model parameter, a score of matching between each of the preset articles and the question, wherein the preset matching model is used to match each of the preset articles and the question for the target article;
outputting, based on the calculating, a corresponding matching score for each of the preset articles and the question; and
outputting, based on scores of matching between each of the preset articles and the question for the target article, an article recommendation list for the question for the target article to permit identification of an application corresponding to the question for the target article.

2. The method of claim 1, wherein inputting each piece of the 2-tuple information into the preset matching model, and calculating, based on the preset matching model parameter, the score of matching between each of the preset articles and the question comprises:
inputting, into the preset matching model, the modal content information of a preset article of the preset articles and the text information of the question for the target article that corresponds to each piece of the 2-tuple information;
loading the preset matching model parameter as a matching score calculation weight of the preset matching model; and
calculating, based on the matching score calculation weight, the score of matching between the preset article and the question for the target article;
using the score of matching obtained as an output of the preset matching model.

3. The method of claim 1, wherein before obtaining the_text information of the question for the target article, the method further comprises:
extracting the modal content information of a preset article in the preset article set;
extracting, from a community question answering database based on a name of the preset article, text information of the question related to the preset article;
constructing a 2-tuple information training sample for the preset article with reference to the modal content information of the preset article and the text information of the question related to the preset article; and
inputting the 2-tuple information training sample into the preset matching model for training to obtain a corresponding preset matching model parameter.

4. The method of claim 1, wherein the modal content information comprises at least one of introduction text information of a preset article of the preset articles, tag information of the preset article of the preset articles, or image display information of the preset article of the preset articles, and wherein before the obtaining, the method further comprises:
constructing the preset matching model based on the modal content information;
using the preset matching model to match the text information of the question with the modal content information in the 2-tuple information; and
outputting the corresponding matching score.

5. The method of claim 4, wherein when the modal content information is the introduction text information of the preset article, constructing the preset matching model based on the modal content information comprises:
constructing a feature vector v_{qe}∈R^{m} of text information of a question related to the preset article, wherein R is a Euclidean space, and wherein m is a dimension of the feature vector v_{qe} of the text information of the question;
constructing a feature vector v_{qe}∈Rⁿ of the introduction text information of the preset article, wherein n is a dimension of the feature vector vₜₑₓₜ of the introduction text information;
projecting the feature vector v_{qe} of the text information of the question and the feature vector vₜₑₓₜ of the introduction text information to a space of a same dimension by using linear projection matrices L_{qe}∈R^{m×k} and Lₜₑₓₜ∈R^{n×k}; and
constructing, using an inner product of hidden layer features, a text matching model Sₜₑₓₜ(v_{qe},vₜₑₓₜ)=<L_{qe}v_{qe},Lₜₑₓₜvₜₑₓₜ>=v^{T}_{qe}L^{T}_{qe}Lₜₑₓₜvₜₑₓₜ to match the text information of the question and the introduction text information, wherein {L_{qe}, Lₜₑₓₜ}∈Θ is a parameter of the text matching model to match the text information of the question and the introduction text information, and wherein Θ is a parameter set of the text matching model.

6. The method of claim 4, wherein when the modal content information is the introduction text information of the preset article, constructing the preset matching model based on the modal content information comprises:
dividing text information of a question related to the preset article into a plurality of first semantic units;
constructing a word feature vector vⁱ_{qe},i=1, . . . ,n of each semantic unit of the first semantic units based on dividing the text information of the question related to the preset article;
dividing the introduction text information of the preset article into a plurality of second semantic units;
constructing a word feature vector vⁱₜₑₓₜ,i=1, . . . ,m of each semantic unit of the second semantic units based on dividing the introduction text information of the preset article;
converting the text information of the question into a word feature vector representation z_{qe}=CNN_{qe}([v¹_{qe},v²_{qe}, . . . ,vⁿ_{qe}];θ_{qe}) using a first convolutional neural network CNN_{qe}(•), wherein θ_{qe} is a parameter of the first convolutional neural network;
converting the introduction text information into a word feature vector representation zₜₑₓₜ=CNNₜₑₓₜ([v¹ₜₑₓₜ,v²ₜₑₓₜ, . . . ,v^{m}ₜₑₓₜ];θₜₑₓₜ) using a second convolutional neural network CNNₜₑₓₜ(•), wherein θₜₑₓₜ is a parameter of the second convolutional neural network; and
constructing, using a feed-forward neural network MLP(•), a text matching model Sₜₑₓₜ(z_{qe},zₜₑₓₜ)=MLP ([z_{qe};zₜₑₓₜ]; wₜₑₓₜ) to match the text information of the question and the introduction text information, wherein wₜₑₓₜ is a parameter of the feed-forward neural network, wherein {θ_{qe},θₜₑₓₜ,wₜₑₓₜ}∈Θ is a parameter of the text matching model to match the text information of the question and the introduction text information, and wherein Θ is a parameter set of the text matching model.

7. The method of claim 4, wherein when the modal content information is the tag information of the preset article, constructing the preset matching model based on the modal content information comprises:
constructing a feature vector v_{qe}∈R^{m} of text information of a question related to the preset article, wherein R is a Euclidean space, wherein m is a dimension of the feature vector v_{qe} of the text information of the question;
constructing a feature vector v_{tag}∈Rⁿ of the tag information of the preset article, wherein n is a dimension of the feature vector v_{tag} of the tag information;
separately projecting the feature vector v_{qe} of the text information of the question and the feature vector v_{tag} of the tag information to a space of a same dimension using linear projection matrices L_{qe}∈R^{m×k} and L_{tag}∈R^{n×k}; and
constructing, using an inner product of hidden layer features, a tag matching model S_{tag}(v_{qe},v_{tag})=<L_{qe}v_{qe},L_{tag}v_{tag}>=v^{T}_{qe}L^{T}_{qe}L_{tag}v_{tag} to match the text information of the question and the tag information, wherein {L_{qe},L_{tag}}∈Θ is a parameter of the tag matching model to match the text information of the question and the tag information, and wherein Θ is a parameter set of the tag matching model.

8. The method of claim 4, wherein when the modal content information is the tag information of the preset article, constructing the preset matching model based on the modal content information comprises:
dividing text information of a question related to the preset article into a plurality of first semantic units;
constructing a word feature vector vⁱ_{qe}, i=1, . . . ,n of each semantic unit of the first semantic units based on dividing the text information of the question related to the preset article;
dividing the tag information of the preset article into a plurality of second semantic units;
constructing a word feature vector vⁱ_{tag}, i=1, . . . ,m of each semantic unit of the second semantic units based on dividing the tag information of the preset article;
converting the text information of the question into a word feature vector representation z_{qe}=CNN_{qe}([v¹_{qe},v²_{qe}, . . . ,vⁿ_{qe}];θ_{qe}) by using a first convolutional neural network CNN_{qe}(•), wherein θ_{qe} is a parameter of the first convolutional neural network;
converting the tag information into a word feature vector representation z_{tag}=CNN_{tag}([v¹_{tag},v²_{tag}, . . . ,v^{m}_{tag}];θ_{tag}) by using a second convolutional neural network CNN_{tag}(•), wherein θ_{tag} is a parameter of the second convolutional neural network; and
constructing, using a feed-forward neural network MLP(•), a tag matching model S_{tag}(z_{qe},z_{tag})=MLP([z_{qe};z_{tag}];w_{tag}) matching the text information of the question and the tag information, wherein w_{tag} is a parameter of the feed-forward neural network, wherein {θ_{qe},θ_{tag},w_{tag}}∈Θ is a parameter of the tag matching model to match the text information of the question and the tag information, and wherein Θ is a parameter set of the tag matching model.

9. The method of claim 4, wherein when the modal content information is the image display information of the preset article, constructing the preset matching model based on the modal content information comprises:
constructing a feature vector vᵢₘ of the image display information of the preset article;
dividing text information of a question related to the preset article into a plurality of semantic units;
constructing a word feature vector vⁱ_{wd} of each semantic unit of the semantic units based on dividing the text information of the question related to the preset article;
calculating, based on the feature vector vᵢₘ of the image display information and the word feature vectors v_{wd}ⁱ of the semantic units, a feature vector v_{JR} of information about matching between the question and an image; and
constructing, based on the feature vector v_{JR} of the information about matching between the question and the image, an image matching model S_{img}=wₛ(σ(wₘ(v_{JR})+bₘ))+bₛ to match the text information of the question and the image display information, wherein {wₘ,bₘ}∈Θ is a hidden layer parameter, wherein {wₛ,bₛ}∈Θ is an output layer parameter used to calculate a final matching score S_{img}, and wherein Θ is a parameter set of the image matching model.

10. The method of claim 4, wherein when the modal content information comprises the introduction text information of the preset article, the tag information of the preset article, and the image display information of the preset article, constructing the preset matching model based on the modal content information comprises:
constructing a text matching model Sₜₑₓₜ^{(p,q)} that matches the introduction text information and text information of a question related to the preset article;
constructing a tag matching model S_{tag}^{(p,q)} that matches the tag information and the text information of the question related to the preset article;
constructing an image matching model S_{img}^{(p,q)} that matches the image display information and the text information of the question related to the preset article; and
constructing, based on each of the text matching model Sₜₑₓₜ^{(p,q)}, the tag matching model S_{tag}^{(p,q)}, and the image matching model S_{img}^{(p,q)}, a multi-modal merging matching model for the question related to the preset article comprising
$${arg max}_{Θ} S ( Θ ) = {argmax}_{Θ} {\sum }_{< p , q > ∈ D} g ( {S}_{img}^{( p , q )} , {S}_{text}^{( p , q )} , {S}_{tag}^{( p , q )} ; Θ ) + λΩ ( Θ ) ,$$
wherein Θ is a parameter set of the multi-modal merging matching model, wherein D is a 2-tuple information training sample set of the preset article, wherein Ω(•) is a regularization item to avoid model over-fitting caused by excessive parameters, and wherein λ is a hyperparameter to balance functions of correlation matching and the regularization item in an optimization problem.

11. A community question answering-based article recommendation system, comprising:
a memory comprising program code; and
a processor coupled to the memory and configured to execute the program code, wherein the program code causes the processor to be configured to:
obtain text information of a question for a target article;
construct 2-tuple information using the text information of the question and modal content information of each of a plurality of preset articles in a preset article set, wherein the target article is any article of the preset articles, wherein the modal content information represents a feature of each of the preset articles, and wherein the 2-tuple information comprises the text information of the question and the modal content information of the preset article;
input each piece of the 2-tuple information into a preset matching model;
calculate, based on a preset matching model parameter, a score of matching between each of the preset articles and the question, wherein the preset matching model is used to match each of the preset articles and the question for the target article;
output a corresponding matching score; and
output an article recommendation list for the question for the target article based on the scores of matching between the plurality of preset articles and the question for the target article so as to permit identification of an application corresponding to the question for the target article.

12. The system of claim 11, wherein the program code further causes the processor to be configured to:
input, into the preset matching model, the modal content information of a preset article of the preset articles and the text information of the question for the target article that corresponds to each piece of the 2-tuple information;
load the preset matching model parameter as a matching score calculation weight of the preset matching model;
calculate, based on the matching score calculation weight, the score of matching between the preset article and the question for the target article; and
use the score of matching as an output of the preset matching model.

13. The system of claim 11, wherein the program code further causes the processor to be configured to:
extract the modal content information of a preset article in the preset article set;
extract, from a community question answering database based on a name of the preset article, text information of the question related to the preset article;
construct a 2-tuple information training sample for the preset article with reference to the modal content information of the preset article and the text information of the question related to the preset article; and
input the 2-tuple information training sample into the preset matching model for training, to obtain a corresponding preset matching model parameter.

14. The system of claim 11, wherein the program code further causes the processor to be configured to
construct the preset matching model based on the modal content information,
use the preset matching model to match the text information of the question with the modal content information in the 2-tuple information; and
output the corresponding matching score.

15. The system of claim 14, wherein the program code further causes the processor to be configured to:
construct a feature vector v_{qe}∈R^{m} of text information of a question related to a preset article of the preset articles, wherein R is a Euclidean space, and wherein m is a dimension of the feature vector v_{qe} of the text information of the question;
construct a feature vector vₜₑₓₜ∈Rⁿ of introduction text information of the preset article, wherein n is a dimension of the feature vector vₜₑₓₜ of the introduction text information;
separately project the feature vector v_{qe} of the text information of the question and the feature vector vₜₑₓₜ of the introduction text information to space of a same dimension by using linear projection matrices L_{qe}∈R^{m×k} and Lₜₑₓₜ∈R^{n×k}; and
construct, using an inner product of hidden layer features, a text matching model Sₜₑₓₜ(v_{qe},vₜₑₓₜ)=<L_{qe}v_{qe}Lₜₑₓₜvₜₑₓₜ>=v^{T}_{qe}L^{T}_{qe}Lₜₑₓₜvₜₑₓₜ for matching the text information of the question and the introduction text information, wherein {L_{qe},Lₜₑₓₜ}∈Θ is a parameter of the text matching model to match the text information of the question and the introduction text information, and wherein Θ is a parameter set of the text matching model.

16. The system of claim 14, wherein the program code further causes the processor to be configured to:
divide text information of a question related to the preset article into a plurality of first semantic units;
construct a word feature vector vⁱ_{qe},i=1, . . . ,n of each units;
divide introduction text information of the preset article into a plurality of second semantic units;
construct a word feature vector vⁱₜₑₓₜ,i=1, . . . ,m of each semantic unit of the second semantic units;
a question text conversion subunit, configured to convert the text information of the question into a word feature vector representation z_{qe}=CNN_{qe}([v¹_{qe},v²_{qe}, . . . ,vⁿ_{qe}];θ_{qe}) using a first convolutional neural network CNN_{qe}(•), wherein θ_{qe} is a parameter of the first convolutional neural network;
convert the introduction text information into a word feature vector representation zₜₑₓₜ=CNNₜₑₓₜ([vₜₑₓₜ¹,vₜₑₓₜ², . . . ,vₜₑₓₜ^{m}];θₜₑₓₜ) using a second convolutional neural network CNNₜₑₓₜ(•), wherein θₜₑₓₜ is a parameter of the second convolutional neural network; and
construct, using a feed-forward neural network MLP(•), a text matching model Sₜₑₓₜ(z_{qe},zₜₑₓₜ)=MLP([z_{qe};zₜₑₓₜ]; wₜₑₓₜ) to match the text information of the question and the introduction text information, wherein wₜₑₓₜ is a parameter of the feed-forward neural network, wherein {θ_{qe},θₜₑₓₜ,wₜₑₓₜ}∈Θ is a parameter of the text matching model to match the text information of the question and the introduction text information, and wherein Θ is a parameter set of the text matching model.

17. The system of claim 14, wherein the program code further causes the processor to be configured to construct a feature vector v_{qe}∈R^{m} of text information of a question related to the preset article, wherein R is a Euclidean space, and wherein m is a dimension of the feature vector v_{qe} of the text information of the question;
construct a feature vector v_{tag}∈Rⁿ of tag information of the preset article, wherein n is a dimension of the feature vector v_{tag} of the tag information;
separately project the feature vector v_{qe} of the text information of the question and the feature vector v_{tag} of the tag information to a space of a same dimension using linear projection matrices L_{qe}∈R^{m×k} and L_{tag}∈R_{n×k}; and
construct, using an inner product of hidden layer features, a tag matching model S_{tag}(v_{qe},v_{tag})=<L_{qe}v_{qe}L_{tag}v_{tag}>=v^{T}_{qe}L^{T}_{qe}L_{tag}v_{tag} to match the text information of the question and the tag information, wherein {L_{qe},L_{tag}}∈Θ is a parameter of the tag matching model to match the text information of the question and the tag information, and wherein Θ is a parameter set of the tag matching model.

18. The system of claim 14, wherein the program code further causes the processor to be configured to:
divide text information of a question related to the preset article into a plurality of first semantic units;
construct a word feature vector vⁱ_{qe},i=1, . . . ,n of each semantic unit of the first semantic units;
divide tag information of the preset article into a plurality of second semantic units;
construct a word feature vector v_{tag}ⁱ,i=1, . . . ,m of each semantic unit of the second semantic units;
convert the text information of the question into a word feature vector representation z_{qe}=CNN_{qe}([v_{qe}¹,v_{qe}², . . . ,v_{qe}ⁿ];θ_{qe}) using a first convolutional neural network CNN_{qe}(•) wherein θ_{qe} is a parameter of the first convolutional neural network;
convert the tag information into a word feature vector representation z_{tag}=CNN_{tag}([v_{tag}¹,v_{tag}², . . . ,v_{tag}^{m}];θ_{tag}) using a second convolutional neural network CNN_{tag}(•), wherein θ_{tag} is a parameter of the second convolutional neural network; and
construct, using a feed-forward neural network MLP(•), a tag matching model S_{tag}(z_{qe},z_{tag})=MLP([z_{qe};z_{tag}];w_{tag}) to match the text information of the question and the tag information, wherein w_{tag} is a parameter of the feed-forward neural network, wherein {θ_{qe},θ_{tag},w_{tag}}∈Θ is a parameter of the tag matching model to match the text information of the question and the tag information, and wherein Θ is a parameter set of the tag matching model.

19. The system of claim 14, wherein the program code further causes the processor to be configured to:
divide text information of a question related to the preset article into a plurality of semantic units;
construct a word feature vector vⁱ_{wd} of each semantic unit of the semantic units;
construct a feature vector vᵢₘ of image display information of the preset article;
calculate, based on the feature vector vᵢₘ of the image display information and the word feature vectors of the semantic units, a feature vector v_{JR} of information about matching between the question and an image; and
a construct, based on the feature vector v_{JR} of the information about matching between the question and the image, an image matching model S_{img}=wₛ(σ(wₘ(v_{JR})+bₘ))+bₛ to match the text information of the question and the image display information, wherein {wₘ,bₘ}∈Θ is a hidden layer parameter, wherein {wₛ,bₛ}∈Θ is an output layer parameter to calculate a final matching score S_{img}, and wherein Θ is a parameter set of the image matching model.

20. The system of claim 14, wherein the program code further causes the processor to be configured to:
construct a text matching model Sₜₑₓₜ^{(p,q)} matching introduction text information and text information of a question related to the preset article;
construct a tag matching model S_{tag}^{(p,q)} to match tag information related to the preset article and the text information of the question related to the preset article;
construct an image matching model S_{img}^{(p,q)} to match image display information related to the preset article and the text information of the question related to the preset article; and
construct, based on each of the text matching model Sₜₑₓₜ^{(p,q)}, the tag matching model S_{tag}^{(p,q)}, and the image matching model S_{img}^{(p,q)}, a multi-modal merging matching model for the question related to the preset article comprising
$${arg max}_{Θ} S ( Θ ) = {argmax}_{Θ} {\sum }_{< p , q > ∈ D} g ( {S}_{img}^{( p , q )} , {S}_{text}^{( p , q )} , {S}_{tag}^{( p , q )} ; Θ ) + λΩ ( Θ ) ,$$
wherein Θ is a parameter set of the multi-modal merging matching model, wherein D is a 2-tuple information training sample set of the preset article, wherein Ω(•) is a regularization item to avoid model over-fitting caused by excessive parameters, and wherein λ is a hyperparameter to balance functions of correlation matching and the regularization item in an optimization problem.

21. A user device for community question answering-based article recommendation, wherein the user device comprises:
a memory configured to store executable program code; and
a processor coupled to the memory and configured to invoke the executable program code, wherein the executable program code causes the processor to be configured to:
obtain text information of a question for a target article;
construct 2-tuple information using the text information of the question and modal content information of each of a plurality of preset articles in a preset article set, wherein the target article is any preset article of the preset articles, wherein the modal content information represents a feature of each of the preset articles, and wherein the 2-tuple information comprises the text information of the question and the modal content information of the preset article;
input each piece of the 2-tuple information into a preset matching model;
calculate, based on a preset matching model parameter, a score of matching between each of the preset articles and the question, wherein the preset matching model is used to match each of the preset articles and the question for the target article;
output a corresponding matching score based on the score of matching; and
output an article recommendation list for the question for the target article based on the scores of matching between the preset articles and the question for the target article to permit identification of an application corresponding to the question for the target article.

22. The user device of claim 21, wherein the executable program code to input each piece of the 2-tuple information into the preset matching model, and calculate, based on the preset matching model parameter, the score of matching between each preset article and the question causes the processor to be configured to:
input, into the preset matching model, the modal content information of a preset article of the preset articles and text information of the question for the target article that corresponds to each piece of the 2-tuple information;
load the preset matching model parameter as a matching score calculation weight of the preset matching model;
calculate, based on the matching score calculation weight, the score of matching between the preset article and the question for the target article; and
use the score of matching as an output of the preset matching model.

23. The user device of claim 21, wherein before the obtaining text information of the question for the target article, the executable program code further causes the processor to be configured to:
extract the modal content information of a preset article in the preset article set;
extract, from a community question answering database based on a name of the preset article, text information of the question related to the preset article;
construct a 2-tuple information training sample for the preset article with reference to the modal content information of the preset article and the text information of the question related to the preset article; and
input the 2-tuple information training sample into the preset matching model for training to obtain a corresponding preset matching model parameter.

24. The user device of claim 21, wherein the modal content information comprises at least one of introduction text information of a preset article of the preset articles, tag information of the preset article, or image display information of the preset article, and wherein before obtaining the text information of the question for the target article, the executable program code further causes the processor to be configured to:
construct the preset matching model based on the modal content information;
use the preset matching model to match the text information of the question with the modal content information in the 2-tuple information; and
output the corresponding matching score.

25. The user device of claim 24, wherein when the modal content information is the introduction text information of the preset article, the executable program code further causes the processor to be configured to:
construct a feature vector v_{qe}∈R^{m} of text information of a question related to the preset article, wherein R is a Euclidean space, and wherein m is a dimension of the feature vector v_{qe} of the text information of the question;
construct a feature vector vₜₑₓₜ∈Rⁿ the introduction text information of the preset article, wherein n is a dimension of the feature vector vₜₑₓₜ of the introduction text information;
separately project the feature vector v_{qe} of the text information of the question and the feature vector vₜₑₓₜ of the introduction text information to space of a same dimension using linear projection matrices L_{qe}∈R^{m×k} and Lₜₑₓₜ∈R^{n×k}; and
construct, using an inner product of hidden layer features, a text matching model Sₜₑₓₜ(v_{qe},vₜₑₓₜ)=<L_{qe}v_{qe},Lₜₑₓₜvₜₑₓₜ>=v^{T}_{qe}L^{T}_{qe}Lₜₑₓₜvₜₑₓₜ to match the text information of the question and the introduction text information, wherein {L_{qe},Lₜₑₓₜ}∈Θ is a parameter of the text matching model for matching the text information of the question and the introduction text information, and wherein Θ is a parameter set of the text matching model.

26. The user device of claim 24, wherein when the modal content information is the introduction text information of the preset article, executable program code further causes the processor to be configured to construct the preset matching model according to:
divide text information of a question related to the preset article into a plurality of first semantic units;
construct a word feature vector v_{qe}ⁱ,i=1, . . . ,n of each semantic unit of the first semantic units;
divide the introduction text information of the preset article into a plurality of second semantic units;
construct a word feature vector vₜₑₓₜⁱ,i=1, . . . ,m of each semantic unit of the second semantic units;
convert the text information of the question into a word feature vector representation z_{qe}=CNN_{qe}([v¹_{qe},v²_{qe}, . . . ,vⁿ_{qe}];θ_{qe}) by using a first convolutional neural network CNN_{qe}(•), wherein θ_{qe} is a parameter of the first convolutional neural network;
convert the introduction text information into a word feature vector representation zₜₑₓₜ=CNNₜₑₓₜ([vₜₑₓₜ¹,vₜₑₓₜ², . . . ,vₜₑₓₜ^{m}];θₜₑₓₜ) using a second convolutional neural network CNNₜₑₓₜ(•), wherein θₜₑₓₜ is a parameter of the second convolutional neural network; and
construct, using a feed-forward neural network MLP(•), a text matching model Sₜₑₓₜ(z_{qe},zₜₑₓₜ)=MLP([z_{qe};zₜₑₓₜ];wₜₑₓₜ) to match the text information of the question and the introduction text information, wherein wₜₑₓₜ is a parameter of the feed-forward neural network, wherein {θ_{qe},θₜₑₓₜ,wₜₑₓₜ}∈Θ is a parameter of the text matching model to match the text information of the question and the introduction text information, and wherein Θ is a parameter set of the text matching model.

27. The user device of claim 24, wherein when the modal content information is the tag information of the preset article, the executable program code further causes the processor to be configured to:
construct a feature vector v_{qe}∈R^{m} of text information of a question related to the preset article, wherein R is Euclidean space, and wherein m is a dimension of the feature vector v_{qe} of the text information of the question;
construct a feature vector v_{tag}∈Rⁿ of the tag information of the preset article, wherein n is a dimension of the feature vector v_{tag} of the text information of the question and the feature vector v_{tag} of the tag information to a space of a same dimension using linear projection matrices L_{qe}∈R^{m×k} and L_{tag}∈R^{n×k}; and
construct, using an inner product of hidden layer features, a tag matching model S_{tag}(v_{qe},v_{tag})=<L_{qe}v_{qe},L_{tag}v_{tag}>=v^{T}_{qe}L^{T}_{qe}L_{tag}v_{tag} to match the text information of the question and the tag information, wherein {L_{qe},L_{tag}}∈Θ is a parameter of the tag matching model to match the text information of the question and the tag information, and wherein Θ is a parameter set of the tag matching model.

28. The user device of claim 24, wherein when the modal content information is the tag information of the preset article, the executable program code further causes the processor to be configured to:
divide text information of a question related to the preset article into a plurality of first semantic units;
construct a word feature vector v_{qe}ⁱ,i=1, . . . ,n of each semantic unit of the first semantic units;
divide the tag information of the preset article into a plurality of second semantic units;
construct a word feature vector v_{tag}ⁱ,i=1, . . . ,m of each semantic unit of the second semantic units;
convert the text information of the question into a word feature vector representation z_{qe}=CNN_{qe}([v_{qe}¹,v_{qe}², . . . ,v_{qe}ⁿ];θ_{qe}) using a first convolutional neural network CNN_{qe}(•), wherein θ_{qe} is a parameter of the first convolutional neural network;
convert the tag information into a word feature vector representation z_{tag}=CNN_{tag}([v_{tag}¹,v_{tag}², . . . ,v_{tag}^{m}];θ_{tag}) using a second convolutional neural network CNN_{tag}(•), wherein θ_{tag} is a parameter of the second convolutional neural network; and
construct, using a feed-forward neural network MLP(•), a tag matching model S_{tag} (z_{qe},z_{tag})=MLP([z_{qe};z_{tag}];w_{tag}) to match the text information of the question and the tag information, wherein w_{tag} is a parameter of the feed-forward neural network, wherein {θ_{qe},θ_{tag},w_{tag}}∈Θ is a parameter of the tag matching model to match the text information of the question and the tag information, and wherein Θ is a parameter set of the tag matching model.

29. The user device of claim 24, wherein when the modal content information is the image display information of the preset article, the executable program code further causes the processor to be configured to:
construct a feature vector vᵢₘ of the image display information of the preset article;
divide text information of a question related to the preset article into a plurality of semantic units;
construct a word feature vector vⁱ_{wd} of each semantic unit of the semantic units;
calculate, based on the feature vector vᵢₘ of the image display information and the word feature vectors vⁱ_{wd} of the semantic units, a feature vector v_{JR} of information about matching between the question and an image; and
construct, based on the feature vector v_{JR} of the information about matching between the question and the image, an image matching model S_{img}=wₛ(σ(wₘ(v_{JR})+bₘ))+bₛ to match the text information of the question and the image display information, wherein {wₘ,bₘ}∈Θ is a hidden layer parameter, wherein {wₛ,bₛ}∈Θ is an output layer parameter to calculate a final matching score S_{img}, and wherein Θ is a parameter set of the image matching model.

30. The user device of claim 24, wherein the modal content information comprises the introduction text information of the preset article, the tag information of the preset article, and the image display information of the preset article, and wherein the executable program code further causes the processor to be configured:
construct a text matching model Sₜₑₓₜ^{(p,q)} to match the introduction text information and text information of a question related to the preset article;
construct a tag matching model S_{tag}^{(p,q)} to match the tag information and the text information of the question related to the preset article;
construct an image matching model S_{img}^{(p,q)} to match the image display information and the text information of the question related to the preset article; and
construct, based on the text matching model Sₜₑₓₜ^{(p,q)}, the tag matching model S_{tag}^{(p,q)}, and the image matching model S_{img}^{(p,q)}, a multi-modal merging matching model for the question related to the preset article comprising
$${arg max}_{Θ} S ( Θ ) = {argmax}_{Θ} {\sum }_{< p , q > ∈ D} g ( {S}_{img}^{( p , q )} , {S}_{text}^{( p , q )} , {S}_{tag}^{( p , q )} ; Θ ) + λΩ ( Θ ) ,$$
wherein Θ is a parameter set of the multi-modal merging matching model, wherein D is a 2-tuple information training sample set of the preset article, wherein Ω(•) is a regularization item to avoid model over-fitting caused by excessive parameters, and wherein λ is a hyperparameter to balance functions of correlation matching and the regularization item in an optimization problem.
